(19) United States
(12) Patent Application Publication
(10) Pub. No.: US 2013/0179563 A1
(43) Pub. Date: Jul. 11, 2013

(54) INFORMATION SYSTEM, COMPUTER AND METHOD FOR IDENTIFYING CAUSE OF PHENOMENON

(71) Applicants: Yusaku Nakamura, Yokohama (JP); Takaki Kuroda, Machida (JP); Takashige Iwamura, Yokohama (JP)

(72) Inventors: Yusaku Nakamura, Yokohama (JP); Takaki Kuroda, Machida (JP); Takashige Iwamura, Yokohama (JP)

(73) Assignee: Hitachi, Ltd.

(21) Appl. No.: 13/580,753

(22) PCT Filed: Jan. 5, 2012
(86) PCT No.: PCT/JP2012/050114

§ 371 Date: Aug. 23, 2012

(51) Int. Cl. G06F 11/30

(52) U.S. Cl. 709/224

(57) ABSTRACT

An information system has a plurality of network apparatuses, a plurality of node apparatuses and a computer that analyzes a cause of an event that occurred. A storage resource for the computer stores rules including conditions indicating events that occur in the network apparatuses and the node apparatuses, and conclusion. The computer generates an aggregate internal condition object for aggregating information on the occurrences of events of a plurality of condition objects corresponding to the conditions of the plurality of network apparatuses, and associates the aggregate internal condition object with the condition objects corresponding to the conditions of the network apparatuses, condition objects corresponding to the conditions of the node apparatuses, and conclusion objects corresponding to the conclusions.

### TECHNICAL FIELD

The present invention relates to a technique to identify a cause of a phenomenon that occurs in a network to which a plurality of node apparatuses belong.

### BACKGROUND ART

A technique to identify a root cause of a phenomenon (hereinafter referred to as “event”), e.g., one relating to a failure or the like in an information processing system having a plurality of apparatuses including a server, a storage and a network apparatus is known.

For example, Patent Literature 1 discloses a technique described below. That is, rule memory data used for analysis of root causes is first stored in a rule memory. Each time a root cause analysis engine receives a notice of an event, it adds data about the event to the rule memory and calculates a matching ratio for a rule relating to the received event in rules contained in the rule memory data. The matching ratio is a measure indicating which rule is significantly probable to provide a conclusion showing a root cause (a probability or a calculated ratio). An analysis engine can identify a root cause based on the calculated matching ratio. Each event has a valid duration. At the expiration of the duration, the data about the event is deleted from the rule memory. The analysis engine recalculates the matching ratio only with respect to the rule affected in relation to the deleted event.

With the technique disclosed in Patent Literature 1, the calculation cost can be reduced because the analysis engine only processes events incrementally or decrementally. Also, because the analysis engine identifies a root cause based on the matching ratio, it can determine the most probable conclusion even if one or more condition elements are not true, thus improving the analysis accuracy.

### CITATION LIST

### Patent Literature

### [Patent Literature 1]

US Patent Application Publication No. 2009/313198

### SUMMARY OF INVENTION

### Technical Problem

The rule memory data used for analysis of a root cause is data including a plurality of rules, information on the occurrences of the events relating to the rules and the matching ratios of the events relating to the rules. The rule memory data is expressed, for example, by a plurality of objects and an object model structured by associating the objects. This object model includes, for example, condition objects corresponding to conditions of the rules, conclusion objects corresponding to conclusions of the rules and operator objects that perform input/output operations between objects. All these objects are stored as data in the memory. Couplings between the objects are stored, for example, as pointer data on the coupling-destination objects in the memory.

In ordinary cases, the root cause analysis technique is introduced into medium-scale to large-scale information processing systems, because small-scale systems have only limited numbers of apparatuses to be monitored; causes can be identified by manual processing in many of such systems; and the need to introduce the root cause analysis technique into such systems is low. On the other hand, in large-scale systems having large numbers of apparatuses to be monitored, it is difficult to identify causes by manual processing, and the introduction of the root cause analysis technique is valuable.

In large-scale systems having large numbers of apparatuses to be monitored, however, the number of rules with which determinations are made is increased in correspondence with the number of apparatuses to be monitored. With the increase in number of rules with which determinations are made, the number of objects and the number of couplings in the object model are increased, resulting in an increase in amount of rule memory data.

### Solution to Problem

An information system has a plurality of network apparatuses forming a plurality of subnetworks, a plurality of node apparatuses belonging to the plurality of subnetworks, and a computer configured to identify a cause of an event which has occurred. The computer has a storage resource, and a control device coupled to the storage resource. The storage resource stores one or more rules and subnetwork information indicating to which networks the network apparatuses and the node apparatuses belong. Each rule includes topology information about a topology including a node apparatus at one end, a node apparatus at the other end and a network apparatus relaying between the node apparatuses, conditions indicating events in the topology, and a conclusion indicating an event occurring as a cause satisfying the conditions.

The control device generates rule memory data and stores the rule memory data in the storage resource by performing (a1) to (a13) in predetermined order, as described below. The predetermined order may be the order of description of (a1) to (a13) or may be any other order if the same rule memory data as that generated by execution in this description order can be generated.

(a1) The control device identifies one or more of the network apparatuses in a first one of the subnetworks based on the subnetwork information, generates one or more first condition objects each configured to manage information on the occurrence of the event corresponding to the condition in the rule, in the network apparatus, when the one or more first condition object do not exist in the rule memory data, and includes the generated one or more first condition objects in the rule memory data.

(a2) The control device generates a first internal condition object configured to aggregate information on the occurrences of all the events of the one or more first condition objects, when the first internal condition object does not exist in the rule memory data, and includes the generated first internal condition object in the rule memory data.

(a3) The control device associates the first internal condition object with the first condition objects.

(a4) The control device identifies one or more of the network apparatuses in a second one of the subnetworks based on the subnetwork information, generates one or more second condition objects each configured to manage information on the occurrence of the event corresponding to the condition in the rule, in the network apparatus, when the one or more second condition object do not exist in the rule memory data, and includes the generated one or more second condition objects in the rule memory data.

(a5) The control device generates a second internal condition object configured to aggregate information on the occurrences of all the events of the one or more second condition objects, when the second internal condition object does not exist in the rule memory data, and includes the generated second internal condition object in the rule memory data.

(a6) The control device associates the second internal condition object with the second condition objects.

(a7) The control device generates an aggregate internal condition object configured to manage aggregate information as an aggregation of information on the occurrences of the events of the first internal condition object and the second internal condition object, when the aggregate internal condition object does not exist in the rule memory data, and includes the generated aggregate internal condition object in the rule memory data.

(a8) The control device associates the aggregate internal condition object with the first and second internal condition objects.

(a9) The control device identifies a plurality of the node apparatuses in the first subnetwork based on the subnetwork information, generates a plurality of third condition objects each configured to manage information on the occurrence of the event corresponding to the condition in the rule, in the node apparatus, when the plurality of third condition objects do not exist in the rule memory data, and includes the generated plurality of third condition objects in the rule memory data.

(a10) The control device generates an aggregate internal conclusion object configured to manage determination information for determining a condition based on the aggregate information from the aggregate internal condition object and the information on the occurrences of the events of the third condition objects, when the aggregate internal conclusion object does not exist in the rule memory data, and includes the generated aggregate internal conclusion object in the rule memory data.

(a11) The control device associates the aggregate internal conclusion object with the aggregate internal condition object and the third condition objects.

(a12) The control device generates a plurality of conclusion objects each configured to manage a measure indicating a possibility that a conclusion indicating the event occurring in one of the network apparatuses in the first subnetwork and the network apparatuses in the second subnetwork shows a cause, when the plurality of conclusion objects do not exist in the rule memory data, and includes the generated plurality of conclusion objects in the rule memory data.

(a13) The control device associates the plurality of conclusion objects with the aggregate internal conclusion object.

The control device receives information on the occurrences of the events in the plurality of network apparatuses or the plurality of node apparatuses, identifies the condition object managing the received occurrence information based on the rule memory data, updates the information on the occurrence of the event managed by the identified condition object, updates the measure of the conclusion object by tracing the association with the condition object and updating the information managed by each object influenced by the update of the occurrence information, and identifies the cause of the event based on the updated measure of the conclusion object and output the cause of the event.

### BRIEF DESCRIPTION OF DRAWINGS

FIG. 1 is a configuration diagram of an information processing system according to an embodiment.

FIG. 2 is a diagram showing a configuration example 1 of the network of the information processing system.

FIG. 3 is a diagram showing an example of a subnet management table in configuration example 1.

FIG. 4 is a diagram showing a configuration example 2 of the network of the information processing system.

FIG. 5 is a diagram showing an example of a subnet management table in configuration example 2.

FIG. 6 is a diagram showing an example of a router management table.

FIG. 7 is a diagram showing an example of an iSCSI target management table.

FIG. 8 is a diagram showing an example of general rules.

FIG. 9 is a diagram showing an example of expanded rules.

FIG. 10 is a diagram showing an example of divided rules in a case where subnets are adjacent to each other.

FIG. 11 is a diagram showing an image of division in a case where subnets are adjacent to each other.

FIG. 12 is a diagram showing an example of divided rules in a case where a subnet intermediates between other subnets.

FIG. 13 is a diagram showing an image of division in a case where a subnet intermediates between other subnets.

FIG. 14 is a diagram showing an example of an event message.

FIG. 15 is a diagram showing an example of an event queue table.

FIG. 16 is a diagram showing an example of rule memory data in configuration example 1.

FIG. 17 is a diagram showing an example of rule memory data in configuration example 2.

FIG. 18 is a flowchart of rule processing.

FIG. 19 is a flowchart of divided rule generation processing.

FIG. 20 is a flowchart of rule memory data generation processing for one subnet.

FIG. 21 is a flowchart of event receiving processing.

FIG. 22 is a flowchart of event writing processing.

### DESCRIPTION OF EMBODIMENT

An embodiment will be described with reference to the drawings. The embodiment described below is not limiting of the invention in accordance with the claim, and all the components and the combinations of the components described in the embodiment are not necessarily indispensable to the solution to the problem according to the invention. In the drawings, the same reference numerals denote the same components through a plurality of figures.

Information items according to the present invention described below by means of expressions such as “aaa table”, “aaa list”, “aaa DB” and “aaa queue” may be expressed as elements other than data structure elements such as a table, a list, a DB and a queue. The information may be referred to as “aaa information” with respect to “aaa table”, “aaa list”, “aaa DB” and “aaa queue” or the like to indicate that the information is independent of the data structure.

In the description below, expressions “identification information”, “identifier”, “name” and “ID” are used for description of the contents of information items. However, these expressions are replaceable with each other.

Further, description may be made below by using “program” or “object” as a subject. However, a program or an object is executed by a processor provided in a control device to perform predetermined processing by using a memory and a communication port (network I/F). Therefore, description may alternatively be made by using “processor” as a subject. Also, processing disclosed by using a program or an object as a subject may be processing performed by a computer such as a monitoring computer or by an information processor. Part or the whole of a program may be realized by a piece of special-purpose hardware. Various programs may be installed in computers through a program distribution server or a computer-readable storage medium.

According to the description below, a CPU (Central Processing Unit) is used as a control device. The control device, however, may comprise a piece of special-purpose hardware for performing predetermined processing (e.g., compression and expansion) as well as a processor such as a CPU.

According to the description below, an “action” of a CPU (and/or a first computer such as a monitoring computer having the CPU) may be an action in which the CPU displays an object or the like on a display device of a first computer having the CPU or an action in which the CPU transmits, to a second computer having a display device, information for a display of an object or the like to be displayed on the display device. When receiving the display information, the second computer can display on the display device the object or the like represented by the display information.

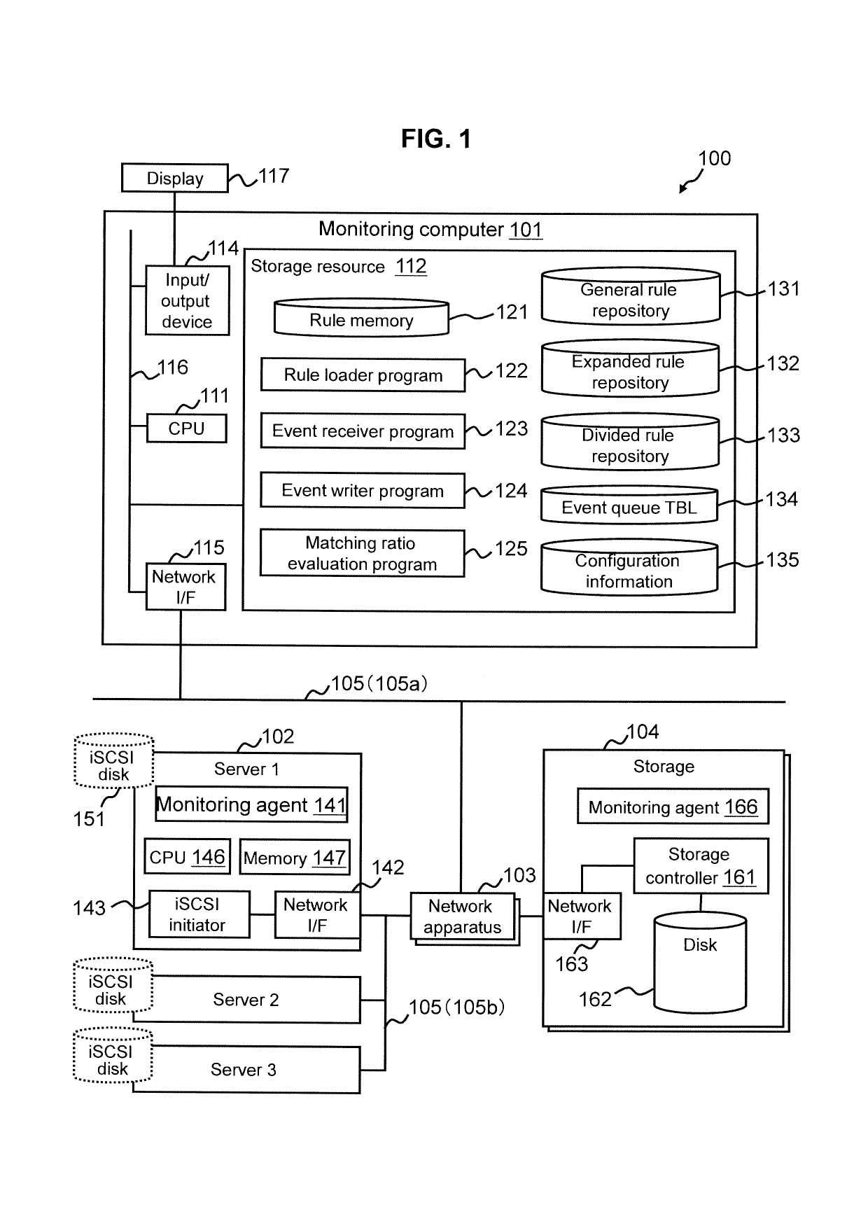

FIG. 1 is a configuration diagram of an information processing system according to one embodiment.

An information processing system 100 has a monitoring computer 101 as an example of a cause analysis apparatus, one or more servers 102, one or more network apparatuses 103, communication networks (105a, 105b, and so on) such as LANs (local area networks), and one or more storages 104. Network apparatus 103 is an IP switch, a router or the like. Monitoring computer 101, server 102 and storage 104 are coupled to each other through communication network 105 and network apparatus 103. Apparatuses (including server 102, storage apparatus 104 and network apparatus 103) constituting information processing system 100 will be hereinafter referred to as “node apparatus”. Information processing system 100 may have, for example, as node apparatuses, a host computer, a NAS (Network Attached Storage), a file server and a printer. Since the node apparatuses are also a target of monitoring with monitoring computer 101, they may be called “monitoring-target apparatus”. Logical or physical constituent members, such as devices, that each node apparatus has are called “component”. Examples of the components are a port, a processor, a storage resource, a storage device, a program, a virtual machine, a logical volume defined in a storage apparatus and a RAID group. If a monitored-target apparatus and a component are treated without being discriminated, they are called “target of monitoring”.

Server 102 is a computer that executes an application or the like. Server 102 has a CPU (Central Processing Unit) 146, a memory 147, a network interface (I/F) 142 and an iSCSI (Internet Small Computer System Interface) initiator 143. Server 102 generates a monitoring agent 141, which is a logical component, by executing a predetermined application with CPU 146. When some event occurs in a target of monitoring, monitoring agent 141 transmits to monitoring computer 101 an event message indicating the occurrence of the event. Server 102 also has an iSCSI disk 151 formed therein. iSCSI disk 151 is a virtual volume in which storage areas of storage 104 are assigned. Server 102 can use iSCSI disk 151 through iSCSI initiator 143 as if iSCSI disk 151 is a local hard disk.

Storage 104 is an apparatus that provides a storage area to server 102 and other apparatuses. Storage 104 has a storage controller 161, a network I/F 163 and a storage medium 162. In the present embodiment, storage medium 162 is a hard disk drive (HDD). However, any other kind of storage medium such as a solid storage medium or an optical storage medium may be used in place of the hard disk drive. Storage 104 provides, for example, server 102 with a storage area for forming iSCSI disk 151. Storage 104 generates a monitoring agent 166, which is a logical component, by executing a predetermined application with a CPU not illustrated. When some event occurs in storage 104, monitoring agent 166 transmits to monitoring computer 101 an event message indicating the occurrence of the event. Monitoring agent 141 of server 102 may be configured so as to be able to monitor an event that occurs in storage 104 and transmit to monitoring computer 101 an event message about the event that occurred in storage 104.

Monitoring computer 101 is a computer that manages monitoring-target apparatuses. Monitoring computer 101 is, for example, a general-purpose computer having a CPU 111, a storage resource 112, an input/output device 114, a system bus 116 and a network I/F 115. Storage resource 112 may be a memory, a secondary storage unit such as a hard disk drive (HDD) or a combination of a memory and a secondary storage unit. CPU 111, storage resource 112, input/output device 114 and network I/F 115 are coupled to each other through system bus 116.

Storage resource 112 stores, for example, a rule memory 121, a rule loader program 122, an event receiver program 123, an event writer program 124, a matching ratio evaluation program 125, a general rule repository 131, an expanded rule repository 132, a divided rule repository 133, an event queue table (TBL) 134 and configuration information 135. Rule loader program 122, event receiver program 123, event writer program 124 and matching ratio evaluation program 125 are executed by CPU 111. In rule memory 121, rule memory data to be used when a root cause is analyzed is stored. In general rule repository 131, one or more general rules are stored. In expanded rule repository 132, one or more expanded rules are stored. In divided rule repository 133, one or more divided rules are stored. General rules, expanded rules and divided rules will be described later with reference to the drawings.

Network I/F 115 is an interface device for coupling to communication network 105. Input/output device 114 is an interface device for coupling to an input/output apparatus. For example, a display 117 is coupled to input/output device 114. Monitoring computer 101 is capable of presenting root cause analysis results or other information to an administrator by displaying the root cause analysis results or other information on display 117. Monitoring computer 101 may incorporate display 117.

Monitoring computer 101 receives from monitoring-target apparatuses various kinds of information, e.g., an event message indicating that an event has occurred in the target of monitoring and information on the overall configuration of the monitoring-target apparatuses or information processing system 100. Monitoring computer 101 performs various kinds of processing, e.g., processing for analyzing a cause of an event based on various kinds of information received from the monitoring-target apparatuses and outputs the results of the processings.

In the present embodiment, several monitoring-target apparatuses are apparatuses that provide network services such as a service to provide an iSCSI volume, a file sharing service and a Web service (hereinafter referred to as “service provision apparatus”). Other several monitoring-target apparatuses are apparatuses that use network services provided by the service provision apparatuses (hereinafter referred to as “service use apparatus”). For example, server 102 corresponds to a service use apparatus because it uses an iSCSI volume provision service provided by storage 104. On the other hand, storage 104 corresponds to a service provision apparatus because it provides the iSCSI volume provision service to server 102, etc. Because service provision apparatuses and service use apparatuses are in a service provision-service use mutual relationship, there is a possibility that an event that has occurred on one of the two kinds of apparatuses will transmit to the other. For example, when a certain event occurs in storage 104 corresponding to a service provision apparatus, there is a possibility of the same event occurring in server 102 (i.e., a service use apparatus) using the network service provided by storage 104.

Configuration information 135 stored in storage resource 112 of monitoring computer 101 will be described. Configuration information 135 is information indicating the configuration of information processing system 100. More specifically, configuration information 135 is information indicating, for example, what node apparatuses are constituting information processing system 100, how node apparatuses are configured (for example, what components the node apparatuses have), how the coupling relationships between node apparatuses or components are, and what inclusion relationships exist between node apparatuses and components. In some cases, configuration information 135 includes information about the provision or use of network services (e.g., identification information about a service use apparatus and information input to a service provision apparatus at the time of use of a network service). Examples of information input to service provision apparatuses are an iSCSI target name and a LUN (logical unit number) input at the time of use of an iSCSI volume provision service and a URL including a Web server name input at the time of use of a Web service.

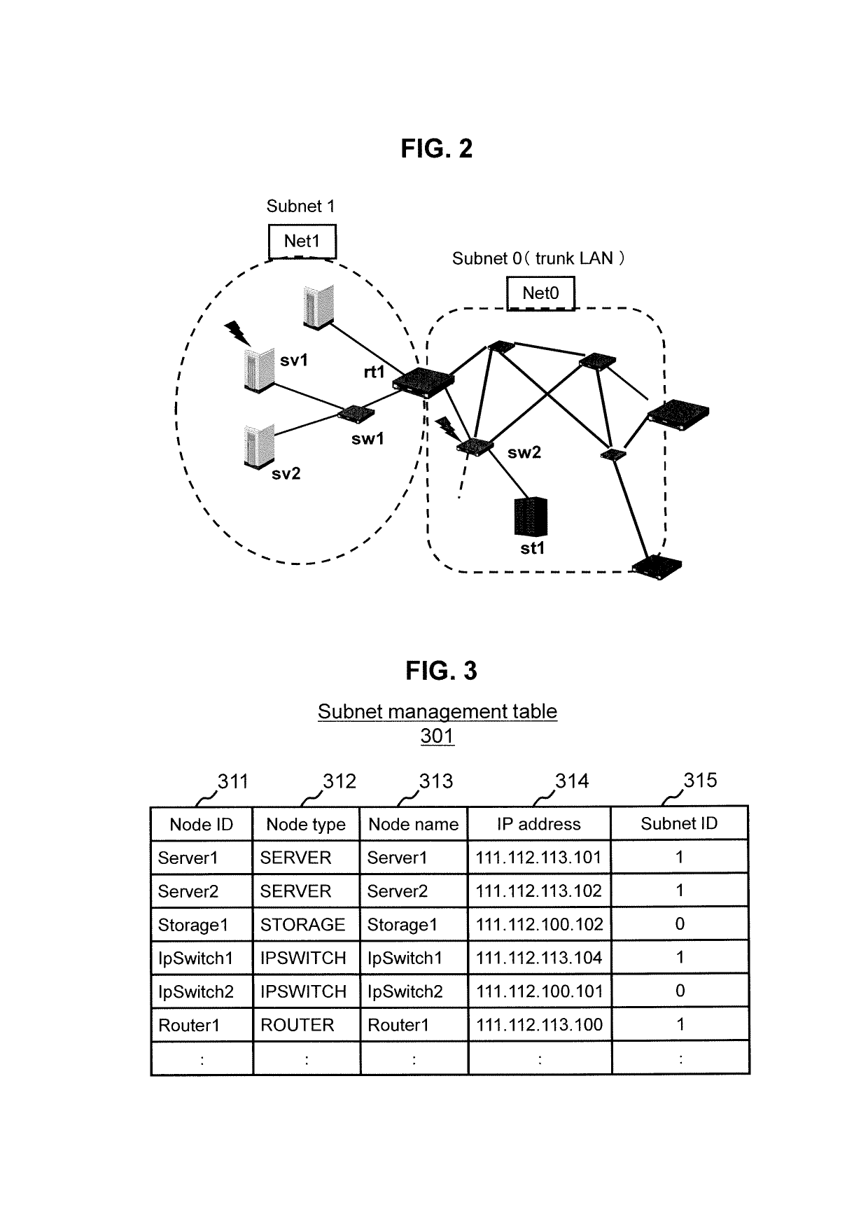

FIG. 2 is a diagram showing a configuration example 1 of the network of the information processing system. In FIG. 2 and other figures, “sv”, “st”, “sw”, “rt” and “Net” denote server 102, storage 104, an IP switch, a router and a subnetwork (subnet), respectively.

In configuration example 1, with respect to an iSCSI volume provision service, servers (sv1, sv2) corresponding to service use apparatuses belong to a subnet 1, while a storage (st1) corresponding to a service provision apparatus belongs to a subnet 0 different from subnet 1. Subnet 1 and subnet 0 are coupled to each other through a router (rt1), which is a network apparatus. In configuration example 1, the subnet to which the server belongs (i.e., subnet 1) and the subnet to which the storage (st1) belongs (i.e., subnet 0) are adjacent to each other.

FIG. 3 is a diagram showing an example of a subnet management table in configuration example 1.

A subnet management table 301 is a table for management of information indicating to which subnets the monitoring-target apparatuses belong. Subnet management table 301 corresponds to part of configuration information 135. In subnet management table 301, node IDs 311 for the node apparatuses, a node types 312 of the node apparatuses, node names 313 of the node apparatuses, IP addresses 314 assigned to the node apparatuses and IDs 315 for the subnets to which the node apparatuses belong are stored by being respectively associated with the node apparatuses.

Node IDs 311 are each an identifier for uniquely identifying one of the node apparatuses. Node types 312 are information indicating the kinds of the node apparatuses. In the present embodiment, a node type “SERVER” represents server 102; a node type “STORAGE”, storage 104; a node type “IPSWITCH”, an IP switch; and a node type “ROUTER”, a router. Subnet IDs 315 are identifiers for uniquely identifying the subnets. In the present embodiment, a subnet ID “0” indicates subnet 0, and a subnet ID “1” indicates subnet 1.

From subnet management table 301 shown in the diagram, it can be understood that server 1 and server 2 belong to subnet 1, and that storage 1 belongs to subnet 0.

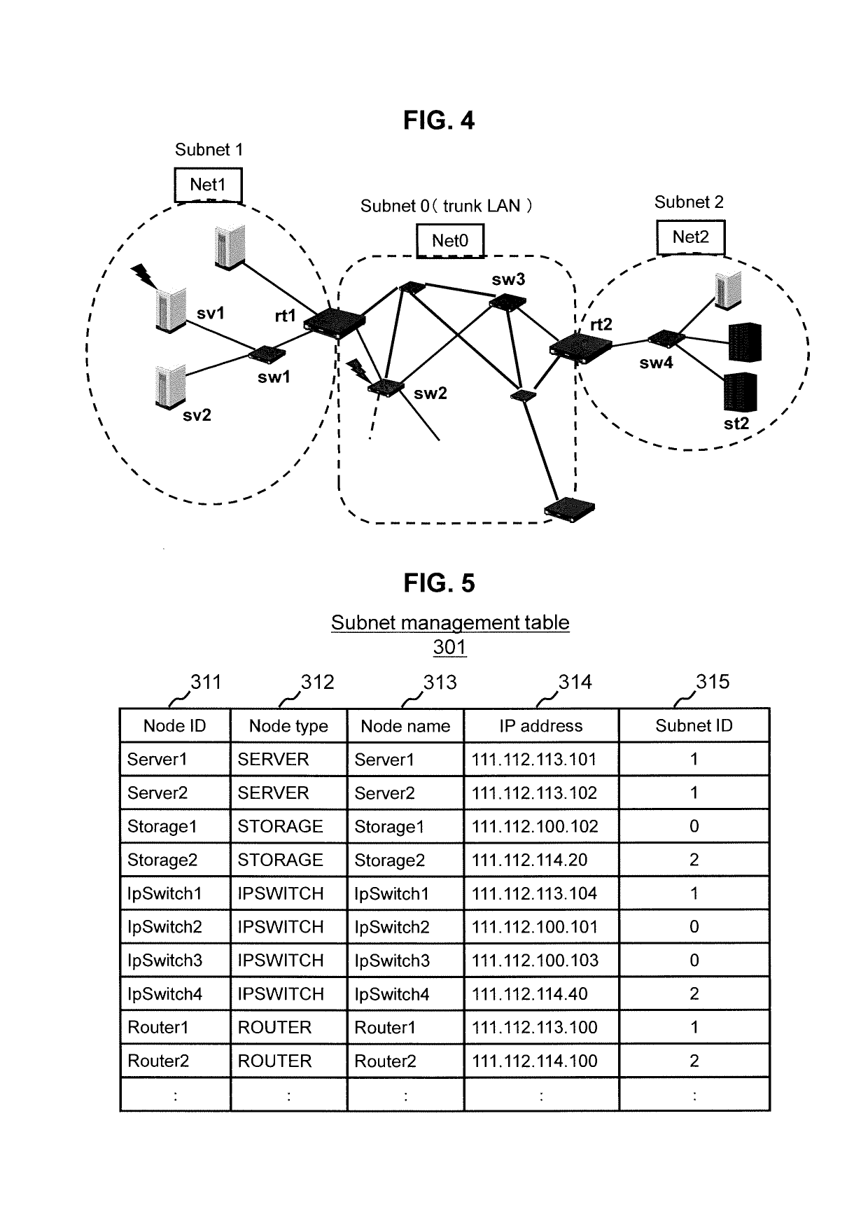

FIG. 4 is a diagram showing a configuration example 2 of the network of the information processing system.

In configuration example 2, with respect to an iSCSI volume provision service, servers (sv1, sv2) corresponding to service use apparatuses belong to a subnet 1, while a storage (st1) corresponding to a service provision apparatus belongs to a subnet 2 different from subnet 1. Subnet 1 and subnet 2 are connected to each other through another subnet 0 (e.g., a trunk LAN). In configuration example 2, the subnet to which the server belongs (i.e., subnet 1) and the subnet to which the storage (st1) belongs (i.e., subnet 2) are connected to each other through the medium of another subnet 0.

FIG. 5 is a diagram showing an example of a subnet management table in configuration example 2.

A subnet management table 301 is the same as subnet management table 301 shown in FIG. 3. By referring to subnet management table 301 shown in FIG. 5, monitoring computer 101 can know that server 1 and server 2 belong to subnet 1, and that storage 2 belongs to subnet 2.

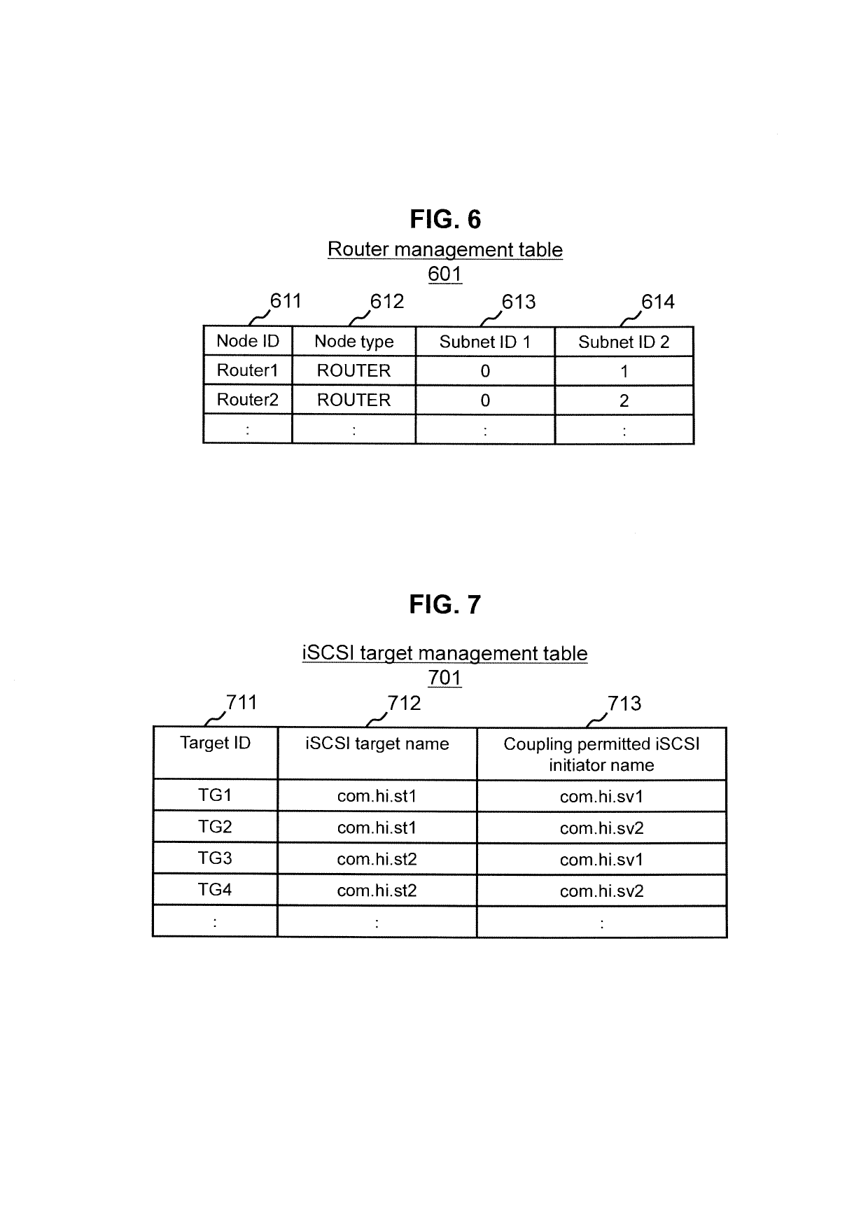

FIG. 6 is a diagram showing an example of a router management table.

A router management table 601 is a table for managing information indicating which subnets routers couple together. Router management table 601 corresponds to part of configuration information 135. In router management table 601, node IDs 611 for routers, node types 612 of the routers and IDs 613 and 614 (subnet ID1, subnet ID2) for the two subnets that the routers couple together, for example, are recorded by being respectively associated with the routers. From router management table 601 shown in the diagram, it can be understood that router 1 couples subnet 0 and subnet 1 together, and that router 2 couples subnet 0 and subnet 2 together.

FIG. 7 is a diagram showing an example of an iSCSI target management table.

An iSCSI target management table 701 is a table for managing information indicating which iSCSI initiator an iSCSI target has permitted to couple to the iSCSI target. iSCSI target management table 701 corresponds to part of configuration information 135. In iSCSI target management table 701, target IDs 711, iSCSI target names 712 and coupling permitted iSCSI initiator names 713, for example, are recorded by being associated.

Target IDs 711 are identifiers assigned to combinations of iSCSI targets and coupling permitted iSCSI initiators (hereinafter referred to as “iSCSI coupling permitted sets”). iSCSI target names 712 are names of iSCSI targets. Coupling permitted iSCSI initiator names 713 are names of iSCSI initiators permitted to couple. For example, from information of a target ID “TG1”, it can be understood that storage 1 as an iSCSI target has permitted server 1 as an iSCSI initiator to couple thereto.

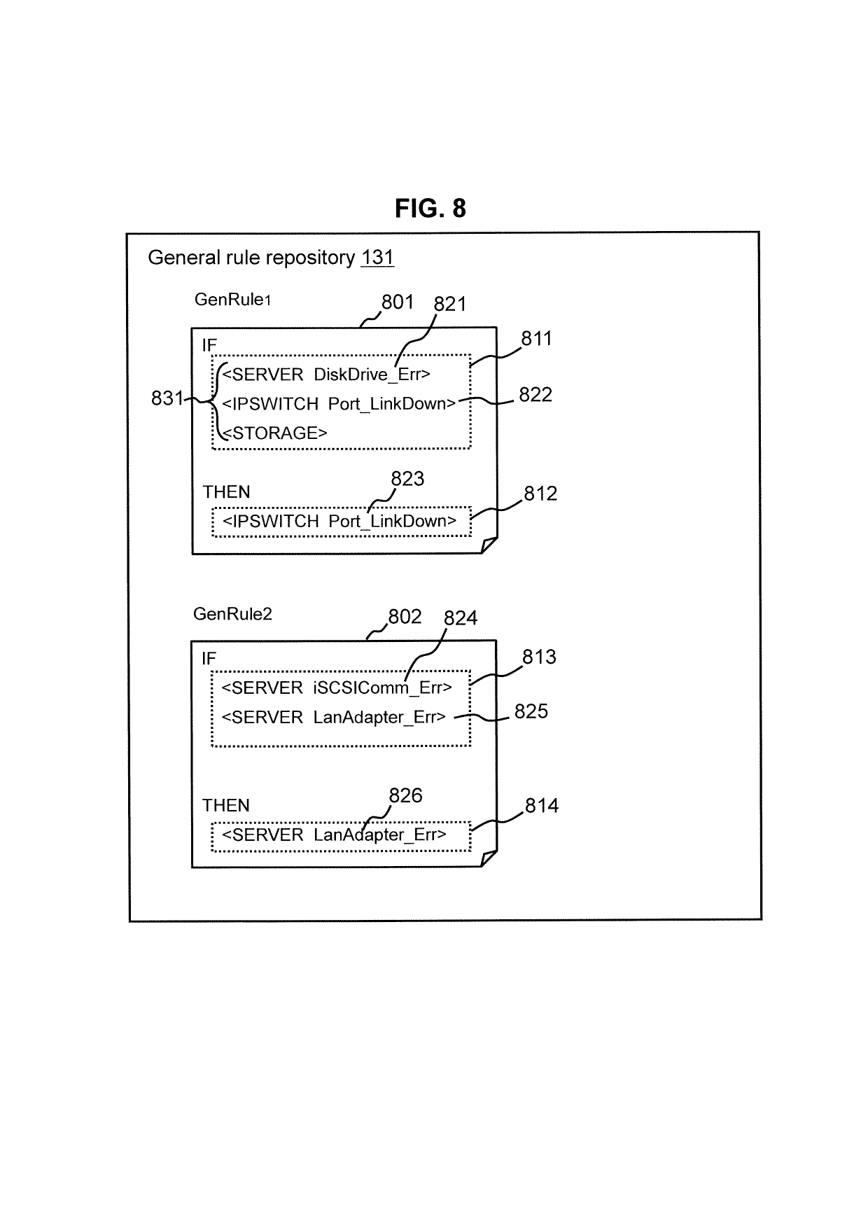

FIG. 8 is a diagram showing an example of general rules.

A general rule is information in which a condition indicating an event and a conclusion indicating an event identified as a cause when the condition is satisfied are described in a form independent of the actual configuration of information processing system 100. A general rule may include a plurality of conditions or a plurality of conclusions. Also, in a case where a general rule includes a condition indicating an event relating to network apparatus 103 (hereinafter referred to as “network event”), the general rule further includes topology information about network apparatus 103 relating to the network event and a service provision apparatus and a service use apparatus coupled to each other through this network apparatus 103. In the description below, a service provision apparatus and a service use apparatus coupled to each other through network apparatus 103 relating to a network event may be referred to as “service provision apparatus relating to a network event” and “service use apparatus relating to a network event”, respectively.

As shown in the diagram, general rules 801 and 802 have IF parts 811 and 813 and THEN parts 812 and 814. Conditions are described in IF parts 811 and 813, while conclusions are described in THEN parts 812 and 814. Each of the conditions and conclusions includes the node type of a node apparatus as an event occurrence source, and the event type of the event.

In general rule 801 (GenRule1), two conditions 821 and 822 are described in IF part 811. Also, one conclusion 823 (“IPSWITCH Port_LinkDown”) is described in THEN part 812. This general rule 801 expresses identifying as a cause an event shown by conclusion 812 when two conditions 821 and 822 are satisfied.

In condition 821, “SERVER DiskDrive_Err” is described, condition 821 indicates that the node type is “SERVER” and the event type is “DiskDrive_Err”. Condition 821 expresses an event: a disk failure occurring in server 102. In condition 822, “IPSWITCH Port_Linkdown” is described, condition 822 indicates that the node type is “IPSWITCH” and the event type is “Port_Linkdown”. Condition 822 expresses an event: a port link failure occurring in an IP switch. Because the event expressed by condition 822 is an event relating to an IP switch, i.e., network apparatus 103, it corresponds to a “network event”. Because general rule 801 thus includes a condition indicating a network event, general rule 801 further includes topology information 831. In the example illustrated in the diagram, topology information 831 includes the node type “IPSWITCH” indicating network apparatus 103 and “SERVER” and “STORAGE” respectively indicating a service provision apparatus and a service use apparatus. This topology information 831 expresses coupling of server 102 and storage 104 through an IP switch.

On the other hand, general rule 802 (GenRule2) includes two conditions 824 and 825 and one conclusion 826. Each of events indicated by conditions 824 and 825 is not a network event. Therefore general rule 802 includes no topology information.

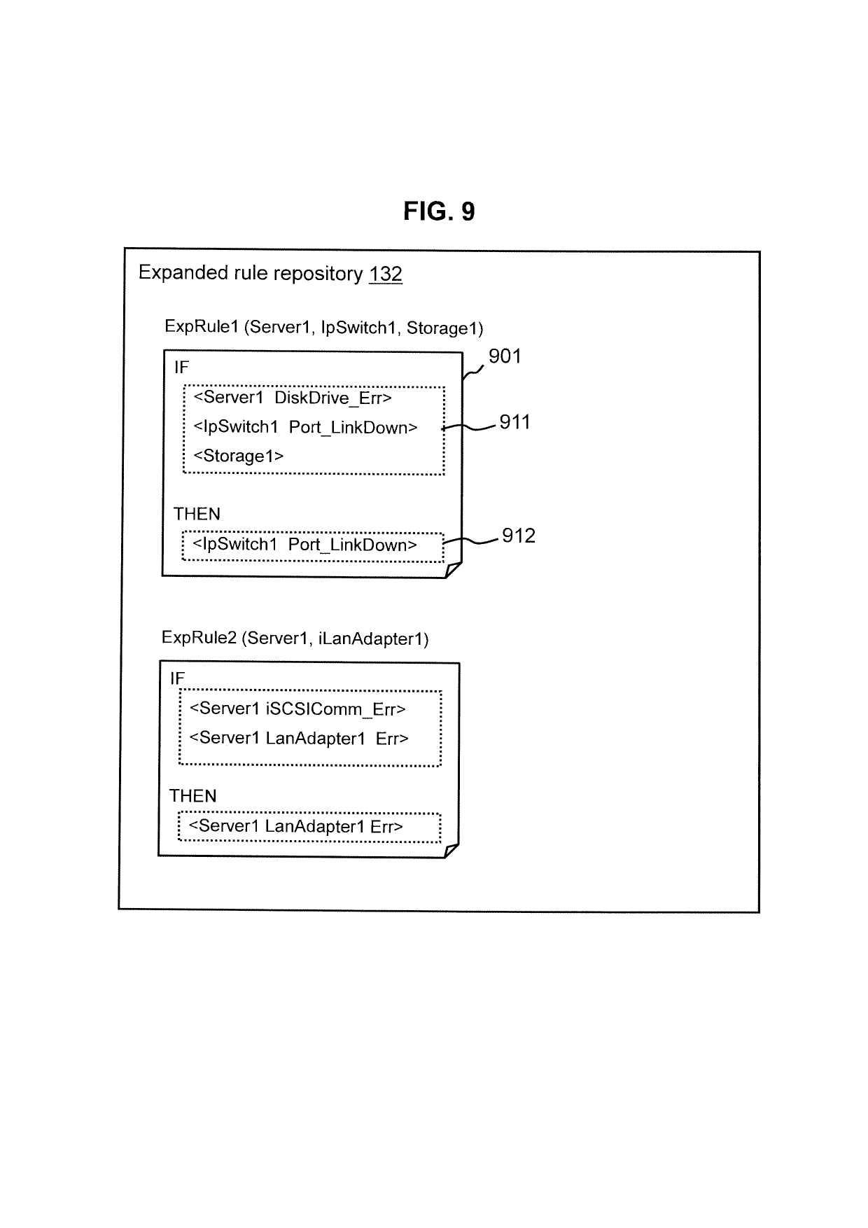

FIG. 9 shows an example of expanded rules.

An expanded rule is information formed by expanding a general rule into a form dependent on the actual configuration of information processing system 100. For example, assuming that information processing system 100 includes one server 102 (server 1), one storage 104 (storage 1) and one IP switch (IP switch 1), general rule 801 shown in FIG. 8 is expanded into an expanded rule 901 (ExpRule1) shown in FIG. 9. Expanded rule 901 includes conditions and a conclusion indicating events relating to targets of monitoring: server 1, storage 1 and IP switch 1 in the actual configuration of information processing system 100. More specifically, expanded rule 901 includes a condition indicating an event: a disk failure that occurs in server 1, and a condition and a conclusion indicating an event: a port link failure that occurs in IP switch 1.

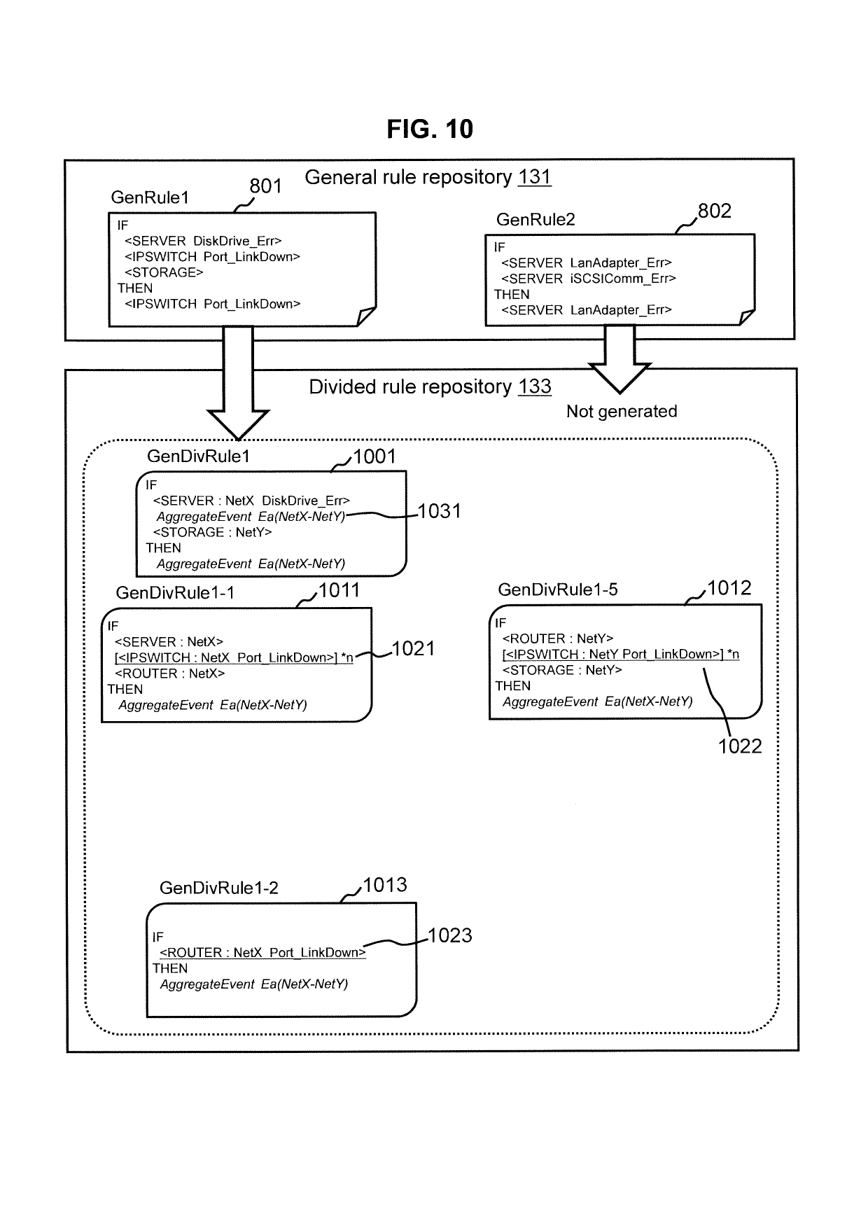

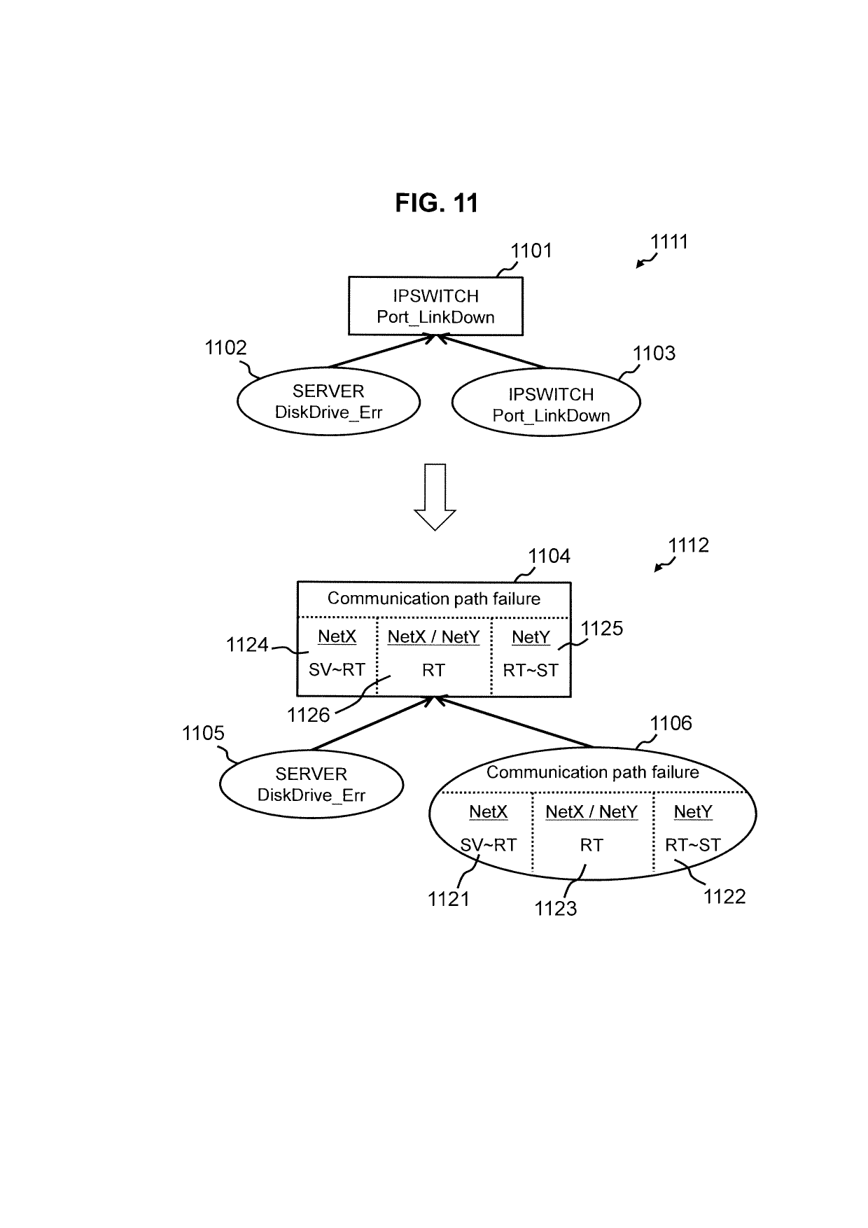

FIG. 10 is a diagram showing an example of divided rules in a case where subnets are adjacent to each other. FIG. 11 is a diagram showing an image of division in a case where subnets are adjacent to each other.

Divided rules are information generated based on a general rule including a condition indicating a network event. Divided rules are generated by dividing a condition included in a general rule and indicating a network event into a plurality of conditions in correspondence with a plurality of groups (e.g., subnets). Not only a condition indicating a network event but also a conclusion indicating a network event may be divided into a plurality of conclusions in correspondence with a plurality of groups (e.g., subnets). In the present embodiment, each of a condition and a conclusion indicating network events is divided into a plurality of conditions or conclusions in correspondence with a plurality of groups.

In the present embodiment, in a case where a subnet to which a service use apparatus relating to a network event (servers 1 and 2 in configuration example 1) belongs (hereinafter referred to as “first subnet”) and a subnet to which a service provision apparatus relating to a network event (storage 1 in configuration example 1) belongs (hereinafter referred to as “second subnet”) are adjacent to each other, a condition and a conclusion indicating network events are divided into a condition and a conclusion indicating an event as an aggregation of network events in the first subnet, a condition and a conclusion indicating an event as an aggregation of network events in the second subnet, and a condition and a conclusion indicating a network event in network apparatus 103 (router 1 in configuration example 1) coupling the first subnet and the second subnet.

In the description below, an event as an aggregation of network events may be referred to as “internal event”, and a condition and a conclusion indicating an internal event may be referred to as “internal condition” and “internal conclusion”, respectively. Also, an event as an aggregation of a plurality of internal events may be referred to as “aggregate internal event”, and a condition and a conclusion indicating an aggregate internal event may be referred to as “aggregate internal condition” and “aggregate internal conclusion”, respectively. Also, an event as an aggregation of network events in a subnet A may be referred to as “internal event relating to subnet A”, and a condition and a conclusion indicating an internal event relating to subnet A may be referred to as “internal condition relating to subnet A” and “internal conclusion relating to subnet A”, respectively. Further, a network event in network apparatus 103 coupling a subnet A and another subnet B may be referred to as “internal event relating to subnet A-B coupling” (or “internal event relating to subnet A-subnet B coupling”), and a condition and a conclusion indicating an internal event relating to subnet A-B coupling may be referred to as “internal condition relating to subnet A-B coupling” and “internal conclusion relating to subnet A-B coupling” (or “internal condition relating to subnet A-subnet B coupling” and “internal conclusion relating to subnet A-subnet B coupling”), respectively.

Division of a condition and a conclusion indicating network events in a case where subnets are adjacent to each other will be described with reference to FIG. 11. Relationship 1111 represents the relationship between events respectively representing conditions and a conclusion with respect to general rule 801. Relationship 1111 indicates identifying an event 1101 as a conclusion when events 1102 and 1103 occur.

Relationship 1112 represents the relationship between events respectively representing conditions and a conclusion with respect to divided rules generated based on general rule 801. An event 1106 is an event corresponding to network event 1103 in general rule 801, indicating that network event 1103 in general rule 801 is divided into a plurality of events 1121, 1122, and 1123. More specifically, as shown in FIG. 11, network event 1103 is divided into internal event 1121 relating to a subnet X (corresponding to the first subnet in this example), internal event 1122 relating to a subnet Y (corresponding to the second subnet in this example) and internal event 1123 relating to subnet X-Y coupling (that is, the condition indicating network event 1103 is divided into an internal condition relating to subnet X, an internal condition relating to subnet Y and an internal condition relating to subnet X-Y coupling). Division of the conclusion is also made in a way similar to that described above. Accordingly, the conclusion indicated by network event 1101 is divided into an internal conclusion relating to subnet X, an internal conclusion relating to subnet Y and an internal conclusion relating to subnet X-Y coupling.

The divided rules shown in FIG. 10 will be described in more detail. As described above and as indicated with respect to network event 1106, the condition indicating network event 1103 is divided into an internal condition relating to subnet X, an internal condition relating to subnet Y and an internal condition relating to subnet X-Y coupling. Accordingly, general rule 801 is divided into a divided rule 1011 including an internal condition 1021 relating to subnet X, a divided rule 1012 including an internal condition 1022 relating to subnet Y and a divided rule 1013 including an internal condition 1023 relating to subnet X-Y coupling.

A condition 1031 represents an aggregate internal condition as an aggregation of internal conditions 1021, 1022, and 1023. Thus, in the present embodiment, a divided rule 1001 including aggregate internal condition 1031 is generated as well as divided rules 1011, 1022, and 1013. Divided rules 1011, 1022, and 1013 have in each of their THEN parts aggregate internal condition 1031 of divided rule 1001 specified therein. This means that the event indicated by the conclusions of divided rules 1011, 1022, and 1013 is the same as the event indicated by aggregate internal condition 1031 (i.e., the aggregate internal event).

General rule 802 includes no condition indicating a network event. Therefore no divided rule is generated based on general rule 802.

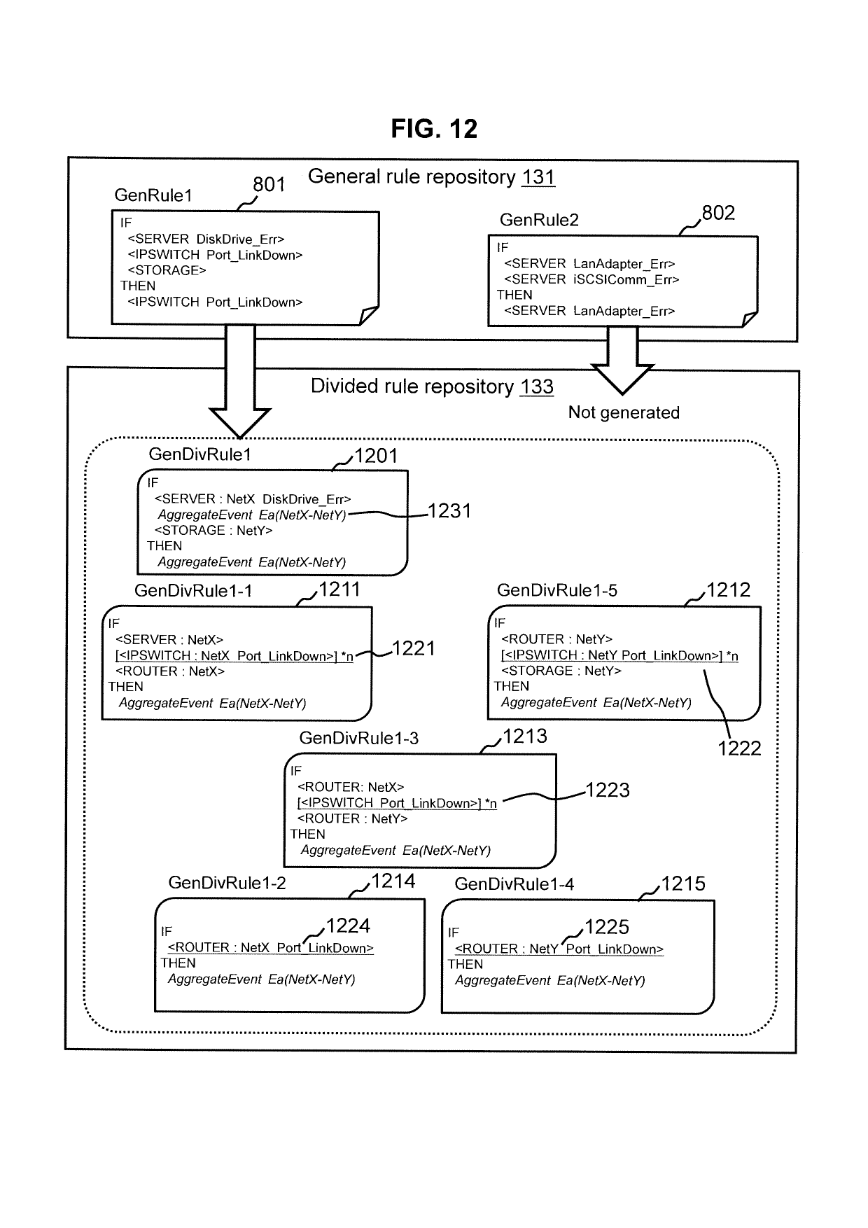

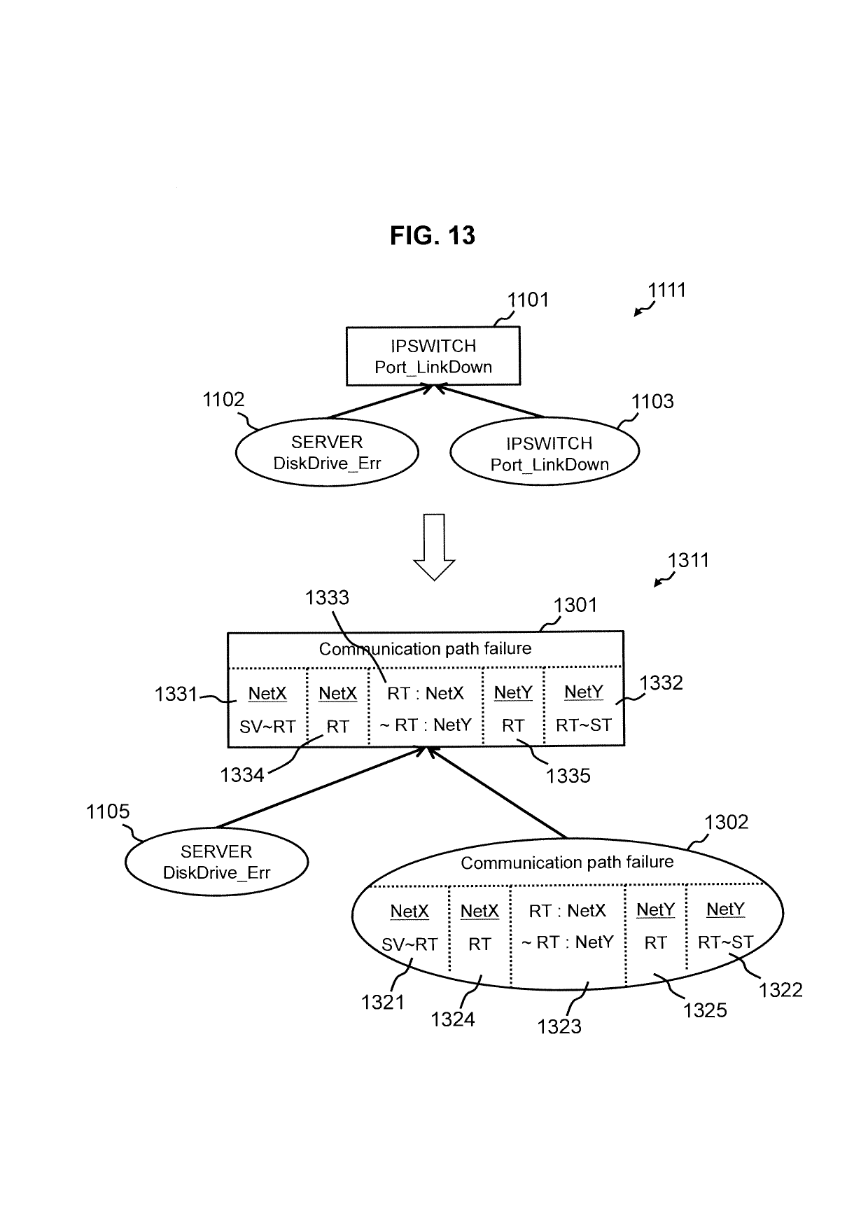

FIG. 12 is a diagram showing an example of divided rules in a case where a subnet intermediates between other subnets. FIG. 13 is a diagram showing an image of division in a case where a subnet intermediates between other subnets.

In the present embodiment, in a case where a subnet other than the first and second subnets intermediates between the first and second subnets as in configuration example 2 shown in FIG. 4, a condition and a conclusion indicating network events are divided into an internal condition and an internal conclusion relating to the first subnet, an internal condition and an internal conclusion relating to the second subnet, an internal condition and an internal conclusion relating to the subnet existing between the first and second subnets (hereinafter referred to as “third subnet”), an internal condition and an internal conclusion relating to the first subnet-third subnet coupling, and an internal condition and an internal conclusion relating to the second subnet-third subnet coupling.

Division of a condition and a conclusion indicating network events in a case where a subnet intermediates between other subnets will be described with reference to FIG. 13. Relationship 1111 between events in general rule 801 is the same as that shown in FIG. 11. An event 1302 indicates that network event 1103 in general rule 801 is divided into an internal event 1321 relating to subnet X (corresponding to the first subnet in this example), an internal event 1322 relating to subnet Y (corresponding to the second subnet in this example), an internal event 1323 relating to the subnet (assumed to be subnet Z, not shown in the diagram) existing between subnet X and subnet Y, an internal event 1324 relating to subnet X-Z coupling, and an internal event 1325 relating to subnet Y-Z coupling. That is, the condition indicating network event 1103 in general rule 801 is divided into an internal condition relating to subnet X, an internal condition relating to subnet Y, an internal condition relating to subnet Z, an internal condition relating to subnet X-Z coupling, and an internal condition relating to subnet Y-Z coupling. The conclusion is also divided in the same way as the condition indicating the network event.

The divided rules shown in FIG. 12 will be described in more detail. As described above and as indicated with respect to network event 1302, the condition indicating network event 1103 is divided into an internal condition relating to subnet X, an internal condition relating to subnet Y, an internal condition relating to subnet Z, an internal condition relating to subnet X-Z coupling, and an internal condition relating to subnet Y-Z coupling. Accordingly, general rule 801 is divided into a divided rule 1211 including an internal condition 1221 relating to subnet X, a divided rule 1212 including an internal condition 1222 relating to subnet Y, a divided rule 1213 including an internal condition 1223 relating to subnet Z, a divided rule 1214 including an internal condition 1224 relating to subnet X-Z coupling, and a divided rule 1215 including an internal condition 1225 relating to subnet Y-X coupling.

As a divided rule, a divided rule 1001 including an aggregate internal condition 1231 as an aggregation of internal conditions 1221, 1222, 1223, 1224, and 1225 is also generated. Divided rules 1211, 1222, 1213, 1214, and 1215 have in each of their THEN parts aggregate internal condition 1231 of divided rule 1201 described therein. Thus, the event indicated by the conclusions of divided rules 1211, 1222, 1213, 1214, and 1215 is the same as the event indicated by aggregate internal condition 1231 (i.e., the aggregate internal event).

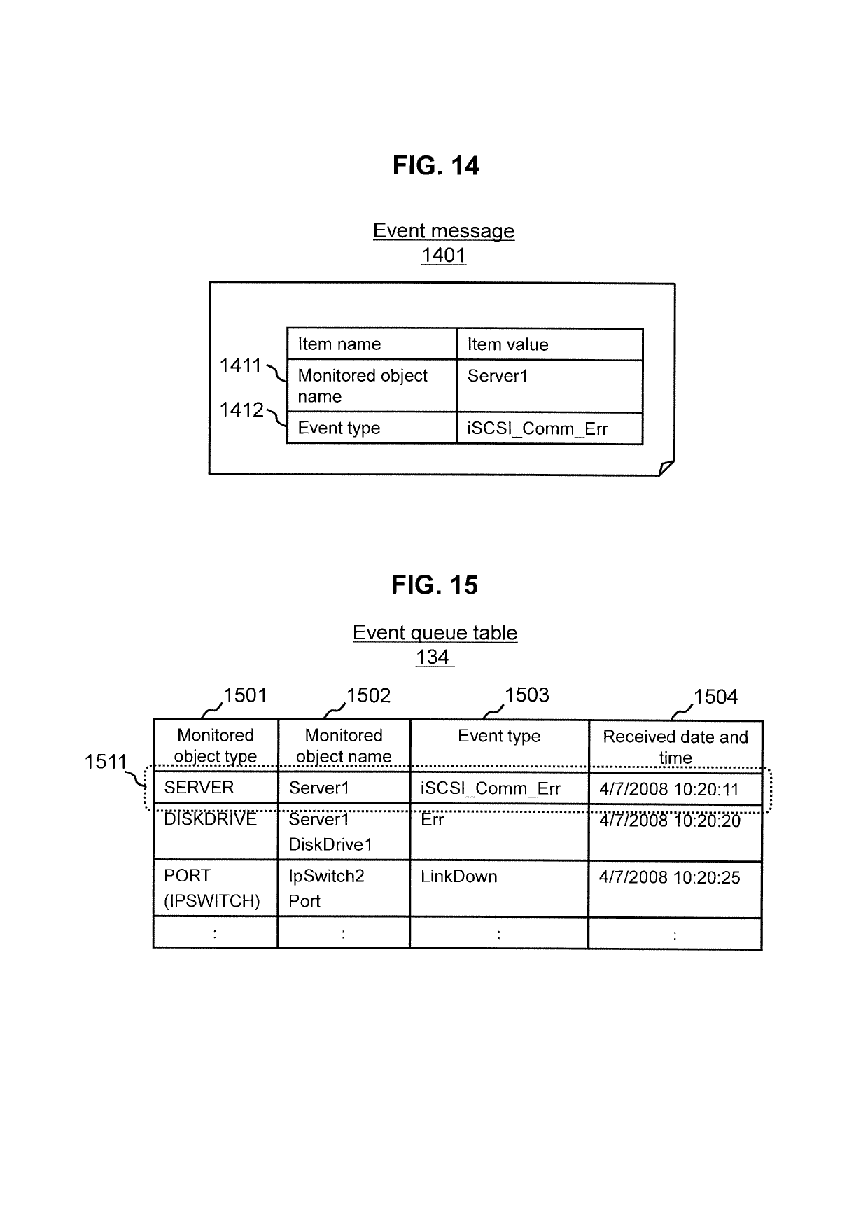

FIG. 14 is a diagram showing an example of an event message.

An event message 1401 is a message for notifying the occurrence of an event in a target of monitoring. Event message 1401 is transmitted to monitoring computer 101 by monitoring agent 141 or 166. Event message 1401 includes, for example, a monitoring-target name 1411 of a target of monitoring as an event occurrence source, and an event type 1412 of an event that occurred. Monitoring-target name 1411 is a name of a target of monitoring. If the target of monitoring is a node apparatus, monitoring-target name 1411 is a node name.

FIG. 15 is a diagram showing an example of the event queue table.

Event queue table 134 is a table for managing event information 1511 about events that occurred. When event receiver program 123 receives event message 1401, it puts in this table event information 1511 about the event notified by means of the received event message 1401. Event queue table 134 functions as a buffer for the event writer program 124. Event writer program 124 obtains event information 1511 from event queue table 134 and updates the details of the rule memory data based on event information 1511. With event queue table 134, event information 1511 about internal events and aggregate internal events, as well as event information about ordinary events that occur in targets of monitoring, may also be managed.

Each piece of event information 1511 includes, for example, a monitoring-target type 1501 of a target of monitoring as an event occurrence source in which an event occurred, a monitoring-target name 1502 of the target of monitoring as the event occurrence source in which the event occurred, an event type 1503 of the event that occurred, and a received date and time 1504 about the event that occurred. Monitoring-target type 1501 is information indicating the kind of the target of monitoring. If the target of monitoring is a node apparatus, monitoring-target type 1501 is a node type (“SERVER”, “STORAGE”, “IPSWITCH”, “ROUTER” or the like). Monitoring-target name 1502 is a name of the target of monitoring. If the target of monitoring is a node apparatus, monitoring-target name 1502 is a node name. Received date and time 1504 is a date and time at which event receiver program 123 received event message 1401.

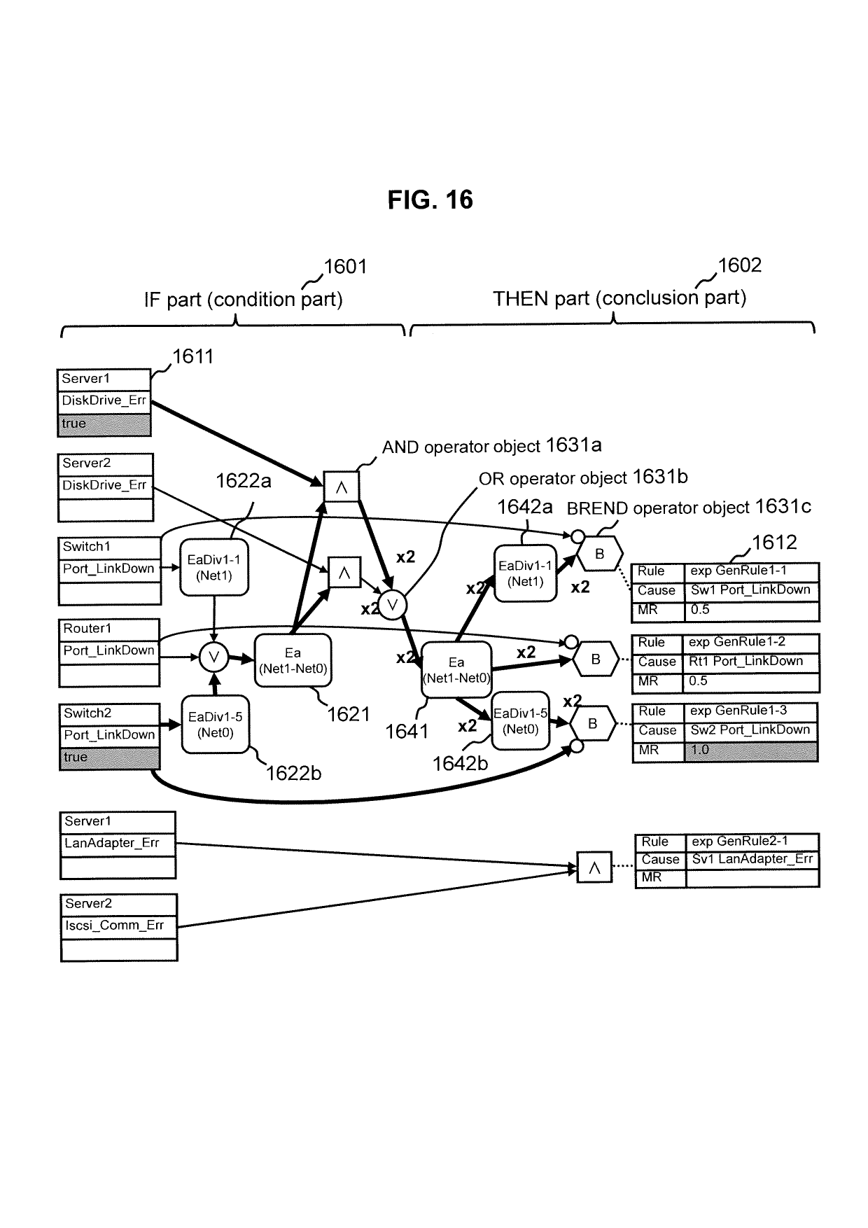

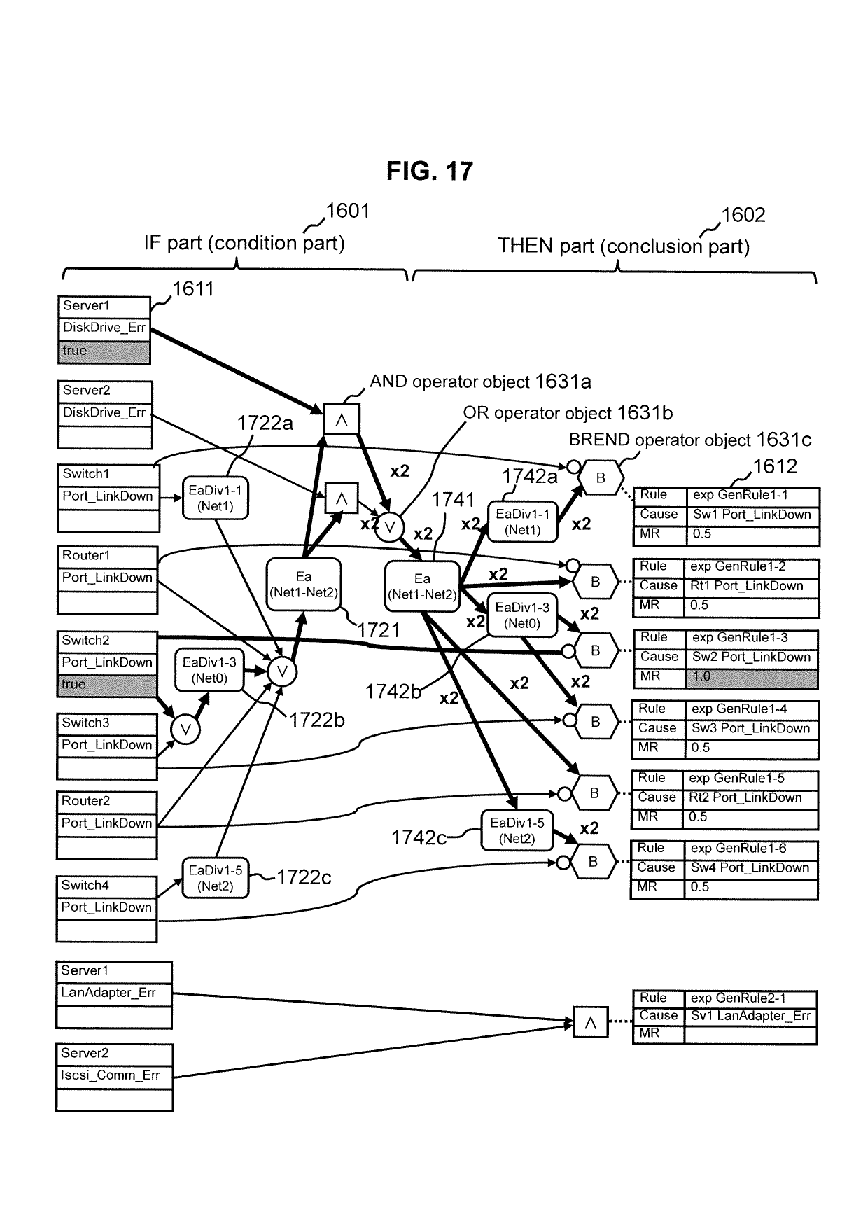

FIG. 16 is a diagram showing an example of rule memory data in configuration example 1. FIG. 17 is a diagram showing an example of rule memory data in configuration example 2.

The rule memory data is data in which at least a plurality of rules used for analysis of a root cause, information on the occurrences of events relating to the rules and information indicating possibilities of the events relating to the rules being the cause are expressed by a plurality of objects and associations between the objects. The rule memory data is generated, for example, based on divided rules and is used at the time of analysis of a root cause.

The rule memory data includes, for example, a condition object 1611, an internal condition object 1622 (1622a, 1622b and so on) or 1722 (1722a, 1722b, 1722c and so on), an aggregate internal condition object 1621 or 1721, a conclusion object 1612, an internal conclusion object 1642 or 1742, an aggregate internal conclusion object 1641 or 1741, an operator object 1631, and information on couplings between the objects. Each object is data (object data) implemented, for example, as a structure or a class in a computer language and stored in storage resource 112 during program operation.

The coupling information is, for example, information in which a pair of identifiers for objects coupled to each other are held. The coupling information includes direction information indicating a relationship in which an output from one of the objects is an input to another of the objects, in other words, an upstream-downstream relationship between the objects. The coupling information also includes thickness information. The thickness information corresponds to the number of inputs to operator object 1631. The thickness information is an important factor in a BLEND operator object 1631c described later. The thickness information may be a value representing a thickness. In FIGS. 16 and 17, the value of the thickness of coupling is indicated by “×numeral”. The thickness of coupling from condition object 1611 is ordinarily set to 1. However, it is not necessarily required that the thickness be set to 1.

Processing described below is performed with respect to coupling of each object. In the following description, one in two of the objects that issues an output to the other (the one coupled on the upstream side of the other) is called “source object”, and the one receiving as an input the output from the other (the one coupled on the downstream side of the other) is called “target object”.

That is, condition object 1611 issues an output to a target object coupled to this condition object 1611. Conclusion object 1612 receives as an input an output from a source object coupled to this conclusion object 1612. Operator object 1631 receives as an input an output from one or more source objects coupled to this operator object 1631, and issues an output to a target object coupled to this operator object 1631. Internal condition object 1622 or 1722, aggregate internal condition object 1621 or 1721, internal conclusion object 1642 or 1742 and aggregate internal conclusion object 1641 or 1741 each receive as an input an output from the corresponding one or ones of source objects coupled to these objects, and issue outputs to target objects coupled to these objects.

Condition object 1611 is an object that manages an event relating to a particular target of monitoring and information on the occurrence of the event. Condition object 1611 corresponds to a condition in an expanded rule or a divided rule. For example, in the examples shown in FIGS. 16 and 17, condition object 1611 manages an event as a disk failure in server 1 and information on the occurrence of the event. For example, when a disk failure occurs in server 1, event information 1511 about the event that occurred is added to event queue table 134 by event receiver program 123. Event writer program 124 then obtains event information 1511 added to event queue table 134 and sets to true (i.e., to 1) the output value of condition object 1611 managing disk failure in server 1. By having the output value set true, condition object 1611 outputs the output value (true) to a target object coupled to condition object 1611.

Operator objects 1631 is an OR operator object 1631b, an AND operator object 1631a or BLEND operator object 1631c.

OR operator object 1631b is an object that issues an output “true (1)” to a target object when one of outputs from one or more source objects is true (1). In matching ratio calculation processing described later, OR operator object 1631b outputs the maximum of outputs from the one or more source objects to the target object. The thickness of coupling of OR operator object 1631b to the target object is equal to the thickness of coupling to the source object.

AND operator object 1631a is an object that issues an output “true” to a target object when all of outputs from one or more source objects are true (1). In matching ratio calculation processing described later, AND operator object 1631a outputs AND output value expressed by an expression 2 shown below to the target object. The thickness of coupling of AND operator object 1631a on the output side is X calculated by expression (1) shown below.

### [Math 1]

X=Σ(i: 1 to the number of inputs)the thickness of input i (Expression 1)

### [Math 2]

AND output value=(Σ(i: 1 to the number of inputs)the value of input i×the thickness of input i)/X (Expression 2)

In these expressions, X represents the sum of the thicknesses of all inputs to the target object for AND operator object 1631a. Other similar descriptions have the same meaning.

Inputs to BLEND operator object 1631c include an input as a basic input (one input in principle) and an input as a delta input. In FIGS. 16 and 17, delta inputs are expressed by coupling marked with a circle. In matching ratio calculation processing described later, BLEND operator object 1631c outputs a BLEND output value expressed by an expression 3 shown below to a target object (typically conclusion object 1612).

### [Math 3]

BLEND output value=(the value of basic input×the thickness of basic input−(1−the value of delta input))/the thickness of basic input (Expression 3)

Each of internal condition objects 1622 and 1722 is an object that aggregates all events managed by condition objects 1611 positioned upstream thereof. Each of internal condition objects 1622 and 1722 manages aggregate information obtained by aggregating event occurrence information from all condition objects 1611 positioned upstream thereof. Internal condition objects 1622 and 1722 correspond to internal conditions in divided rules (internal conditions 1021 to 1023 in FIG. 10 and internal conditions 1221 to 1225 in FIG. 12).

In the example shown in FIG. 16, internal condition object 1622a (EaDiv1-1(Net1)) corresponds to internal condition 1021 in divided rule 1011 relating to subnet X (identified as subnet 1), and aggregates information on the occurrence of network events in subnet 1 (one network event in switch 1 in this example). Internal condition object 1622b (EaDiv1-5(Net0)) corresponds to internal condition 1022 in divided rule 1012 relating to subnet Y (identified as subnet 0), and aggregates information on the occurrence of network events in subnet 0 (one network event in switch 2 in this example).

In the example shown in FIG. 17, internal condition object 1722b (EaDiv1-3(Net0)) corresponds to internal condition 1223 in divided rule 1213 relating to subnet Z (identified as subnet 0 existing between subnet 1 and subnet 2), and aggregates information on the occurrence of network events in subnet 0 (two network event in switch 2 and switch 3 in this example). The thickness of each of internal condition objects 1622 and 1722 to the target object is equal to the thickness of coupling from the source object.

Each of aggregate internal condition objects 1621 and 1721 is an object that aggregates all events managed by internal condition object 1622 or 1722 positioned upstream thereof. Each of aggregate internal condition objects 1621 and 1721 manages aggregate information obtained by aggregating event occurrence information from all the internal condition objects 1622 or 1722 positioned upstream thereof. Aggregate internal condition objects 1621 and 1721 correspond to aggregate internal conditions in divided rules (aggregate internal condition 1031 in FIG. 10 and aggregate internal condition 1231 in FIG. 12).

In the example shown in FIG. 16, aggregate internal condition object 1621 (Ea(Net1-Net0)) corresponds to aggregate internal condition 1031 in divided rule 1001, and aggregates event occurrence information from all of internal condition objects 1622a and 1622b and condition object 1611 managing information on the occurrence of a network event in router 1. That is, aggregate internal condition object 1621 (Ea(Net1-Net0)) aggregates information on the occurrence of network events in all the network apparatuses 103 (switch 1, switch 2 and router 1) in subnet 1 and subnet 0.

In the example shown in FIG. 17, aggregate internal condition object 1721 (Ea(Net1-Net2)) corresponds to aggregate internal condition 1231 in divided rule 1201, and aggregates event occurrence information from all of internal condition objects 1722a, 1722b, and 1722c, condition object 1611 managing information on the occurrence of network events in router 1 and condition object 1611 managing information on the occurrence of network events in router 2. That is, aggregate internal condition object 1721 (Ea(Net1-Net2)) aggregates information on the occurrence of network events in all the network apparatuses 103 (switches 1 to 4 and routers 1 and 2) in subnet 1 and subnet 2 and between subnet 1 and subnet 2.

Conclusion object 1612 is an object that manages an event relating to a particular target of monitoring (a network event in FIGS. 16 and 17) and a measure (e.g., a matching ratio) indicating a possibility that a conclusion indicating the event shows the cause. Conclusion object 1612 corresponds to a conclusion in an expanded rule or the like. For example, in the example shown in FIGS. 16 and 17, conclusion object 1612 manages an event: a network failure in switch 1 and a measure indicating a possibility of the event being the cause.

Internal conclusion objects 1642 (1642a, 1642b and so on) and 1742 (1742a, 1742b, 1742c and so on) are objects that aggregate all events to be managed by conclusion objects 1612 positioned downstream thereof. Internal conclusion objects 1642 and 1742 correspond to internal conclusions in divided rules. For example, in the example shown in FIG. 16, internal conclusion object 1642a (EaDiv1-1(Net1)) corresponds to the internal conclusion in divided rule 1011 and aggregates network events in subnet 1 (one network event in switch 1 in this example). Internal conclusion object 1642b (EaDiv1-5(Net0)) corresponds to the internal conclusion in divided rule 1012 and aggregates network events in subnet 0 (one network event in switch 2 in this example). In the example shown in FIG. 17, internal conclusion object 1742b (EaDiv1-3(Net0)) corresponds to the internal conclusion in divided rule 1213 and aggregates network events in subnet 0 (two network events in switch 2 and switch 3 in this example).

Aggregate internal conclusion objects 1641 and 1741 are objects that aggregate all events to be aggregated in internal conclusion objects 1622 and 1742 positioned downstream thereof. Aggregate internal conclusion objects 1641 and 1741 correspond to aggregate internal conclusions in divided rules. For example, in the example shown in FIG. 16, aggregate internal conclusion object 1641 (Ea(Net1-Net0)) corresponds to the aggregate internal conclusion in divided rule 1001 and aggregates all events to be aggregated (managed) by internal conclusion objects 1642a and 1642b and condition object 1611 for a network event in router 1. That is, aggregate internal conclusion object 1641 (Ea(Net1-Net0)) aggregates network events in all the network apparatuses 103 (switch 1, switch 2 and router 1) in subnet 1 and subnet 0. In the example shown in FIG. 17, aggregate internal conclusion object 1741 (Ea(Net1-Net2)) corresponds to the aggregate internal conclusion in divided rule 1201 and aggregates all events to be aggregated (or managed) by internal conclusion objects 1742a, 1742b, and 1742c, condition object 1611 managing information on the occurrence of a network event in router 1 and condition object 1611 managing information on the occurrence of a network event in router 2. That is, aggregate internal conclusion object 1741 (Ea(Net1-Net2)) aggregates information on the occurrence of network events in all the network apparatuses 103 (switches 1 to 4 and routers 1 and 2) in subnet 1 and subnet 2 and between subnet 1 and subnet 2.

Objects, defined as internal condition objects 1622 and 1722, aggregate internal condition objects 1621 and 1721, internal conclusion objects 1642 and 1742 or aggregate internal conclusion objects 1641 and 1741, may have, in data structure, a flag indicating whether or not at least the corresponding event has been detected (that is, event writer program 124 has obtained event information 1511). In the present embodiment, the objects each issuing a plurality of outputs exist. However, the number of outputs from these objects may be limited to one and a multiplexer object supplied with this output and issuing a plurality of outputs may be provided.

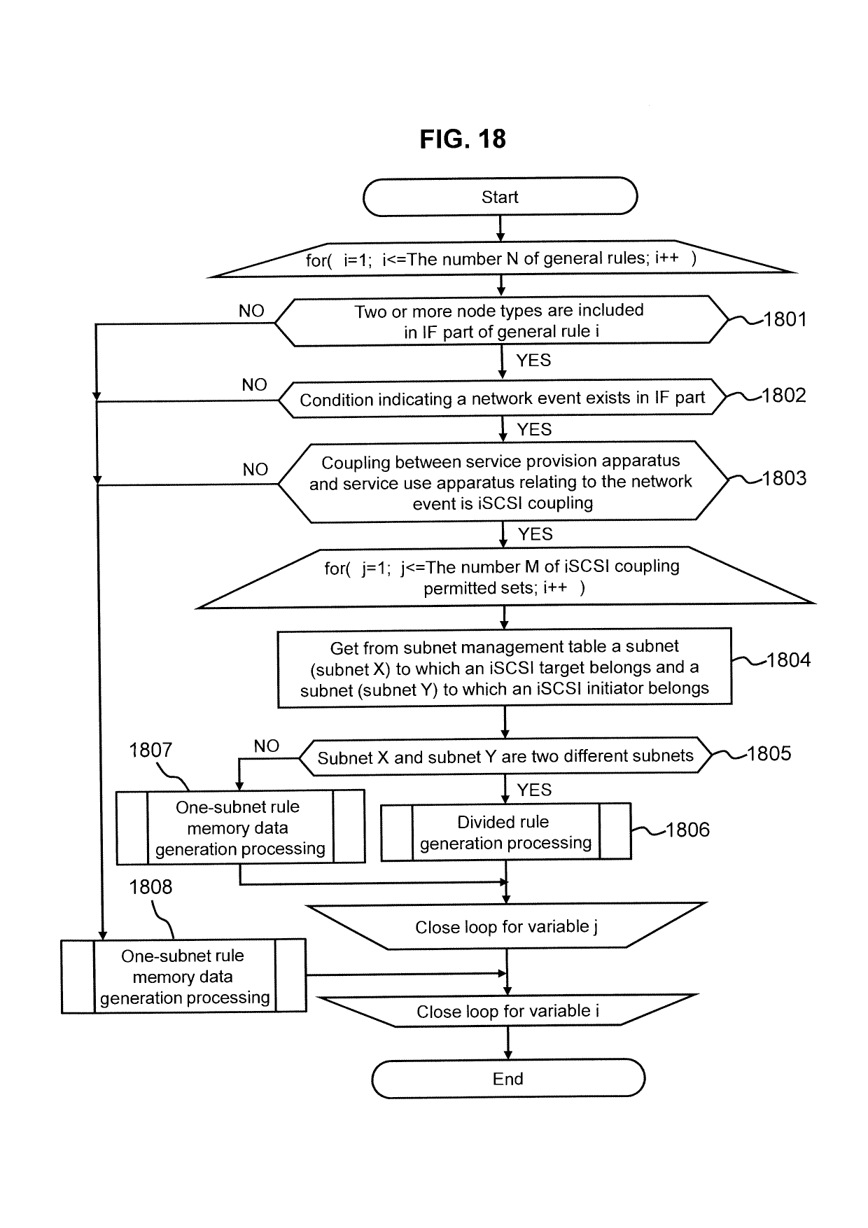

FIG. 18 is a flowchart of rule processing.

Rule processing (processing in steps 1801 to 1808) is repeatedly performed the number of times corresponding to the number of general rules existing in general rule repository 131.

(Step 1801) Rule loader program 122 selects one general rule i and determines whether or not two or more node types are contained in the IF part of the selected general rule i.

(Step 1802) If two or more node types are contained in the IF part of general rule i (step 1801: YES), rule loader program 122 determines whether or not a condition indicating a network event is contained in the IF part of general rule i.

(Step 1803) If a condition indicating a network event is contained in the IF part of general rule i (step 1802: YES), rule loader program 122 determines whether or not the coupling between a service provision apparatus relating to the network event and a service use apparatus relating to the network event is iSCSI coupling.

If the coupling between the service provision apparatus relating to the network event and the service use apparatus relating to the network event is iSCSI coupling (step 1803: YES), rule loader program 122 repeatedly performs processing in steps 1804 to 1807 the number of times corresponding to the number of iSCSI coupling permitted sets existing in iSCSI target management table 701.

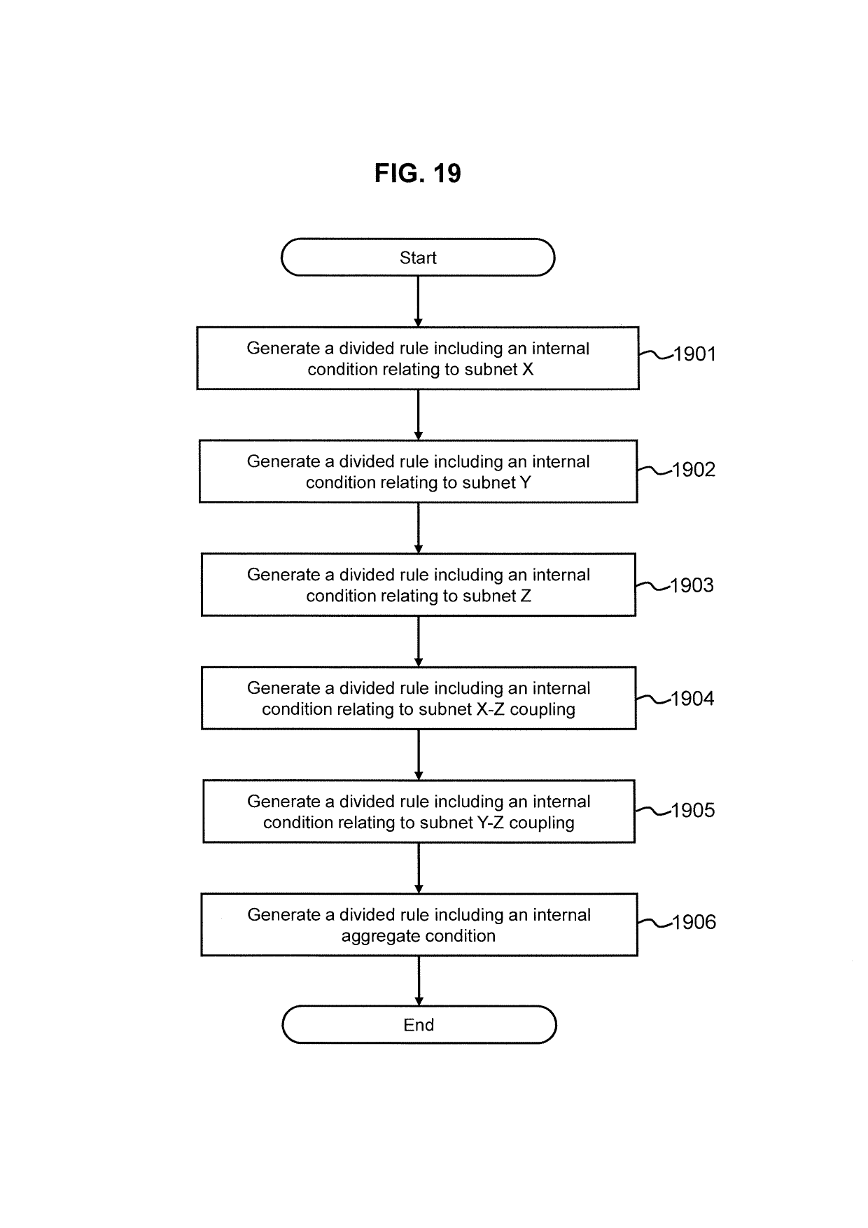

(Step 1804) Rule loader program 122 selects one iSCSI coupling permitted set j from subnet management table 301 and obtains a subnet to which an iSCSI target contained in the iSCSI coupling permitted set j belongs (subnet X in FIGS. 18 and 19) and a subnet to which an iSCSI initiator contained in the iSCSI coupling permitted set j belongs (subnet Y in FIGS. 18 and 19).

(Step 1805) Rule loader program 122 determines whether or not subnet X and subnet Y are two different subnets.

(Step 1806) If subnet X and subnet Y are two different subnets (step 1805: YES), rule loader program 122 performs divided rule generation processing (see FIG. 19). After the completion of divided rule generation processing, rule loader program 122 newly selects one iSCSI coupling permitted set and again performs processing in steps 1804 to 1807 on the selected iSCSI coupling permitted set.

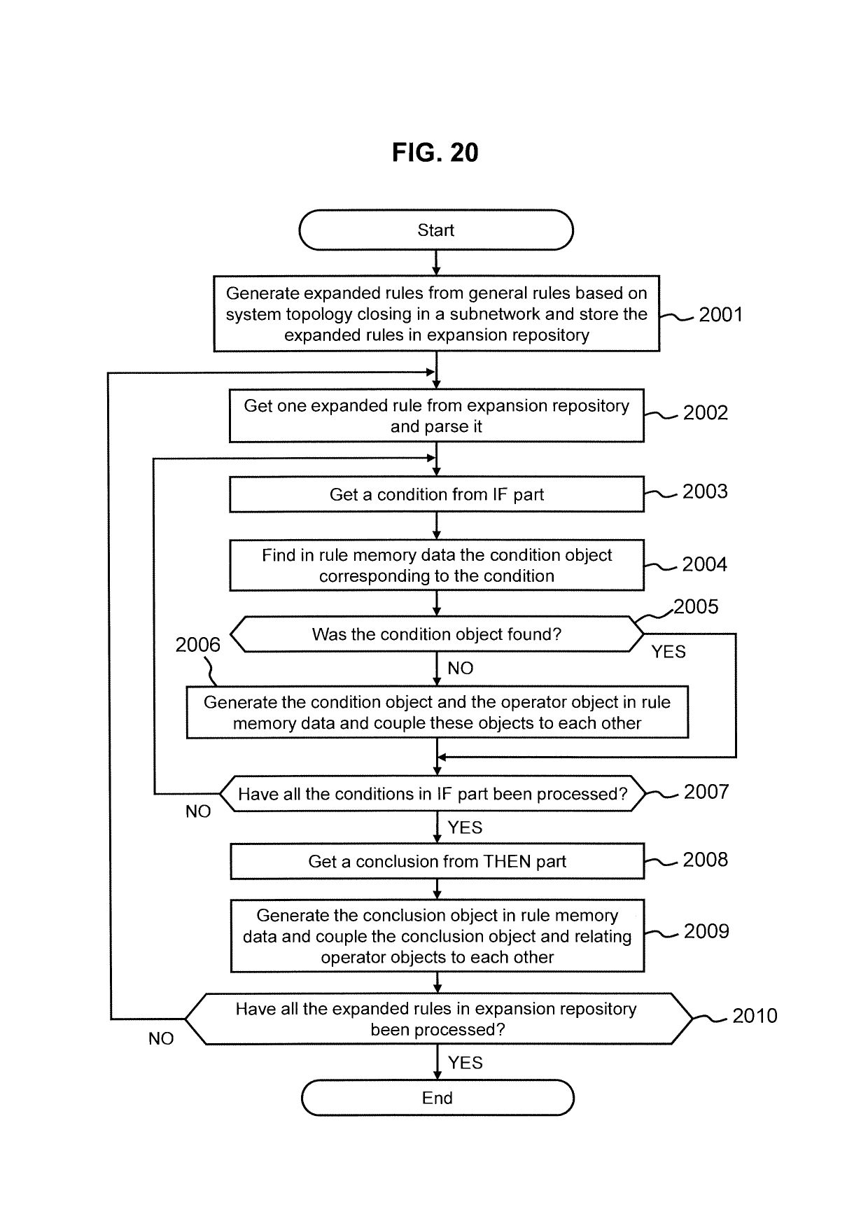

(Step 1807) If subnet X and subnet Y are one and the same (step 1805: NO), rule loader program 122 performs rule memory data generation processing for one subnet (see FIG. 20). After the completion of rule memory data generation processing for one subnet, rule loader program 122 newly selects one iSCSI coupling permitted set and again performs processing in steps 1804 to 1807 on the selected iSCSI coupling permitted set.

(Step 1808) If two or more node types are not contained in the IF part of general rule i in step 1801 (step 1801: NO), if no condition indicating a network event is contained in the IF part of general rule i in step 1802 (step 1802: NO), or if the coupling between the service provision apparatus and the service use apparatus relating to the network event is not iSCSI coupling, then rule loader program 122 performs rule memory data generation processing for one subnet. After the completion of rule memory data generation processing for one subnet, rule loader program 122 newly selects one general rule and again performs processing in steps 1801 to 1808 on the selected general rule.

When processing in steps 1801 to 1808 is completed with respect to all the general rules existing in general rule repository 131, rule loader program 122 stops rule processing.

In the present embodiment, as described above, in a case where a subnet to which a service use apparatus relating to the network event belongs and a subnet to which a service provision apparatus relating to the network event belongs are two different subnets, divided rules are generated based on a general rule. If these subnets are one and the same, rule memory data is generated based on a general rule or an expanded rule expanded from the general rule without generating any divided rules. That is, divided rules are generated based on a common general rule or rule memory data can be directly generated. Therefore rule maker's labor and time are not increased.

FIG. 19 is a flowchart of divided rule generation processing. Processing shown in FIG. 19 is performed in a case where a subnet other than subnet X and subnet Y (assumed to be subnet Z according to the example shown in FIGS. 12 and 13) intermediates between subnet X and subnet Y. In a case where subnet X and subnet Y are adjacent to each other, processing in step 1903 and either of processing in step 1904 and processing in step 1905 may be omitted.

The descriptions as to how a condition and a conclusion in a general rule are divided and what divided rules are thereby generated in a case where a subnet intermediates between other subnets have been made with reference to FIGS. 12 and 13. That is, the condition and the conclusion indicating network event 1103 in general rule 801 are divided into internal condition 1221 and an internal conclusion relating to subnet X, internal condition 1222 and an internal conclusion relating to subnet Y, internal condition 1223 and an internal conclusion relating to subnet Z, internal condition 1224 and an internal conclusion relating to subnet X-Z coupling, internal condition 1225 and an internal conclusion relating to subnet Y-Z coupling, thereby generating divided rule 1211 including internal condition 1221 relating to subnet X, divided rule 1212 including internal condition 1222 relating to subnet Y, divided rule 1213 including internal condition 1223 relating to subnet Z, divided rule 1214 including internal condition 1224 relating to subnet X-Z coupling and divided rule 1215 including internal condition 1225 relating to subnet Y-Z coupling. Also, divided rule 1001 including aggregate internal condition 1231 as an aggregation of all the internal conditions: internal condition 1221 relating to subnet X, internal condition 1222 relating to subnet Y, internal condition 1223 relating to subnet Z, internal condition 1224 relating to subnet X-Z coupling and internal condition 1225 relating to subnet Y-Z coupling is generated.

(Step 1901) Rule loader program 122 generates divided rule 1211 including internal condition 1221 relating to subnet X.

(Step 1902) Rule loader program 122 generates divided rule 1212 including internal condition 1222 relating to subnet Y.

(Step 1903) Rule loader program 122 generates divided rule 1213 including internal condition 1223 relating to subnet Z.

(Step 1904) Rule loader program 122 generates divided rule 1214 including internal condition 1224 relating to subnet X-Z coupling.

(Step 1905) Rule loader program 122 generates divided rule 1215 including internal condition 1225 relating to subnet Y-Z coupling.

(Step 1906) Rule loader program 122 generates divided rule 1001 including aggregate internal condition 1231 as an aggregation of all the internal conditions 1221 to 1225 (i.e., AggregateEvent).

Divided rules 1211 to 1215 including internal conditions 1221 to 1225 are generated so that the conditions indicating network events, topology information about the network apparatuses and the node apparatuses coupled through the network apparatuses and information indicating to which subnets the network apparatuses and the node apparatuses coupled through the network apparatuses belong are contained in the IF parts thereof. Also, an aggregate internal conclusion, AggregateEvent, is contained in the THEN parts. AggregateEvent is generated on an event-by-event basis with respect to events in subnet X, subnet Y and network apparatuses 103 (with respect to the kinds of events described in the original general rule). For example, a divided rule for the general rule including linkdown in a condition and a divided rule for the general rule including a processor failure in a switch are different from each other.

AggregateEvent means that a fact that an event included in the condition in the general rule has occurred in some network apparatus 103 in the communication channel from a node apparatus in subnet X to a node apparatus in subnet Y is set as a condition or a conclusion. Therefore, division into divided rules 1211 to 1215 is in such a form as to be independent of the kinds of events in server 102 and storage 104 in the general rule as the basis of division. Therefore, one division rule can be used in common with respect to iSCSI error in server 102 and DNS error (assuming that a DNS server exists in subnet Y).

It is thought that the IP switch designated in divided rule 1211 or 1212 is a switch used in common in communication to subnet Y (or subnet X) in subnet X (or subnet Y) by any apparatuses. However, the switch is not necessarily used in this way. For example, in a case where all tablet computers in subnet X communicate through switch A (a wireless access point) while a server computer does not communicate through switch A, switch A is treated in divided rule 1211 when a general rule applied only to the tablet computers is a consideration.

FIG. 20 is a flowchart of rule memory data generation processing for one subnet.

(Step 2001) Rule loader program 122 generates expanded rules from general rules based on the system topology of information processing system 100, and stores the generated expanded rules in expanded rule repository 132.

(Step 2002) Rule loader program 122 obtains one expanded rule from expanded rule repository 132 and parses the obtained expanded rule.

(Step 2003) Rule loader program 122 obtains a condition from the IF part of the expanded rule obtained in step 2002.

(Step 2004) Rule loader program 122 examines whether or not the condition object corresponding to the condition obtained in step 2003 exists in rule memory data.

(Step 2005) If the corresponding condition object is not found (step 2005: NO), rule loader program 122 advances the process to step 2006. If the condition object is found (step 2005: YES), rule loader program 122 advances the process to step 2007.

(Step 2006) Rule loader program 122 generates in the rule memory data the condition object and the operator object for the condition obtained in step 2003. Also, rule loader program 122 couples the newly generated condition object and the operator object to each other.

(Step 2007) Rule loader program 122 determines whether or not the processing with respect to all the conditions in the IF part is completed. If the processing is completed (step 2007: YES), rule loader program 122 advances the process to step 2008. If one or more of the conditions are left unprocessed (step 2007: NO), rule loader program 122 advances the process to step 2003.

(Step 2008) Rule loader program 122 obtains a conclusion from the THEN part of the expanded rule obtained in step 2002.

(Step 2009) Rule loader program 122 generates in the rule memory data the conclusion object corresponding to the conclusion obtained in step 2008. Also, rule loader program 122 couples the generated conclusion object and all the relating operator objects to each other. Further, if two or more conclusions are obtained in step 2008, rule loader program 122 also generates the corresponding conclusion objects in the rule memory data with respect to the obtained conclusions, and couples the generated conclusion objects and the relating operator objects to each other.

(Step 2010) Rule loader program 122 determines whether or not the processing with respect to all the expanded rules in the expanded rule repository 132 is completed. If the processing is completed (step 2010: YES), rule loader program 122 ends the rule memory data generation processing for one subnet. If one or more of the expanded rules are left unprocessed (step 2010: NO), rule loader program 122 advances the process to step 2002.

Rule memory data generation processing in a case where a plurality of subnets are included according to the present embodiment will next be described.

This rule memory data generation processing is executed after the execution of divided rule generation processing.

(Step 3001) Rule loader program 122 examines the details of all divided rules and extracts aggregate internal conditions, internal conditions, aggregate internal conclusions and internal conclusions contained in the divided rules. Rule loader program 122 advances the process to step 3002.

(Step 3002) Rule loader program 122 starts a loop (loop 1) in which processing from the following step 3003 is repeated with respect to each of the aggregate internal conditions, internal conditions, aggregate internal conclusions and internal conclusions extracted in step 3001. For ease of understanding of description, processing will be described by assuming that only divided rules in a case where one subnet intermediates other subnets (the aggregate internal conditions, internal conditions, aggregate internal conclusions and internal conclusions contained in divided rules 1201 and 1211 to 1215 in FIG. 12) have been extracted.

<1. Generation of IF Part of Rule Memory Data>

<1.1 Generation of Aggregate Internal Condition Object (Ea(NetX-NetY))>

(Step 3003) Rule loader program 122 generates in IF part 1601 of rule memory data an aggregate internal condition object (Ea(NetX-NetY)) corresponding to aggregate internal condition 1231 (Ea(NetX-NetY)) extracted from divided rule 1201, and advances the process to step 3004. If an aggregate internal condition object (Ea(NetX-NetY)) corresponding to aggregate internal condition 1231 (Ea(NetX-NetY)) exists in the rule memory data, the corresponding object is not generated because the existing aggregate internal condition object can be used. Already existing aggregate internal condition objects can be used as described above, so that the amount of rule memory data can be reduced. For example, this aggregate internal condition object (Ea(NetX-NetY)) can be used in common in cause analysis on each of a plurality of service use apparatuses (e.g., servers) belonging to subnet X and using a service provision apparatus (e.g., a storage) belonging to subnet Y.

Subnets X and Y represent subnets to which node apparatuses mutually providing/using services (i.e., a service provision apparatus and a service use apparatus) belong. Subnet X is a subnet to which server 102 as a service use apparatus belongs, while subnet Y is a subnet to which storage 104 as a service provision apparatus belongs (see divided rule 1201). For example, in a case where information processing system 100 has the same configuration as configuration example 2, server 1 belongs to subnet 0 while storage 2 belongs to subnet 2. Accordingly, aggregate internal condition object (Ea(Net1-Net2)) is generated (aggregate internal condition object 1721 in FIG. 17). Also, rule loader program 122 generates OR operator object 1631b on the upstream side of the aggregate internal condition object in the IF part generated as described above. Rule loader program 122 then generates a coupling from the generated OR operator object 1631b toward the generated aggregate internal condition object. That is, rule loader program 122 generates a coupling such that the output value of OR operator object 1631b is the input value of aggregate internal condition object 1721.

<1.2. Generation of Internal Condition Object>

<1.2.1. Generation of Internal Condition Object (EaDiv1-1(NetX))>

(Step 3004) Rule loader program 122 searches for network apparatus 103 belonging to subnet X and used for communication between subnet X and subnet Y (an IP switch in the divided rule in FIG. 12) based on the details of internal condition 1221 extracted from divided rule 1211. Rule loader program 122 advances the process to step 3005.

(Step 3005) Rule loader program 122 generates, in the IF part, an internal condition object (EaDiv1-1(NetX)) corresponding to internal condition 1221 extracted from divided rule 1211. If internal condition object (EaDiv1-1(NetX)) corresponding to internal condition 1221 exists in the rule memory data, the corresponding object is not generated. Already existing internal condition objects can be used as described above, so that the amount of rule memory data can be reduced. Subnet X is a subnet to which a server 102 as a service use apparatus belongs, and server 1 belongs to subnet 1 in the case where information processing system 100 has the same configuration as configuration example 2. Accordingly, internal condition object (EaDiv1-1(Net1)) is generated (internal condition object 1722a in FIG. 17). Also, rule loader program 122 generates OR operator object 1631b (not shown in FIG. 17) on the upstream side of the generated internal condition object in the IF part. Rule loader program 122 then generates a coupling from the generated OR operator object 1631b toward the generated internal condition object. Rule loader program 122 thereafter advances the process to step 3006.

(Step 3006) Rule loader program 122 generates condition objects corresponding to conditions relating to network apparatuses 103 in subnet X (an IP switch in the divided rule in FIG. 12). If condition objects corresponding to the conditions exist in the rule memory data, the corresponding objects are not generated. Already existing condition objects can be used as described above, so that the amount of rule memory data can be reduced. In the case where information processing system 100 has the same configuration as configuration example 2, subnet X is subnet 1 and switch 1 belongs to subnet 1. Accordingly, a condition object corresponding to a condition relating to switch 1 is generated. Also, rule loader program 122 generates a coupling from each generated condition object toward the OR operator object 1631b generated in step 3005. Rule loader program 122 thereafter advances the process to step 3007.

<1.2.2. Generation of Internal Condition Object (EaDiv1-5(NetX))>

(Step 3007) Rule loader program 122 searches for network apparatus 103 belonging to subnet Y and used for communication between subnet X and subnet Y (an IP switch in the divided rule in FIG. 12) based on the details of internal condition 1222 extracted from divided rule 1212. Rule loader program 122 thereafter advances the process to step 3008.

(Step 3008) Rule loader program 122 generates, in the IF part, an internal condition object (EaDiv1-5(NetY)) corresponding to internal condition 1222 extracted from divided rule 1212. If internal condition object (EaDiv1-5(NetY)) corresponding to internal condition 1222 exists in the rule memory data, the corresponding object is not generated. Already existing internal condition objects can be used as described above, so that the amount of rule memory data can be reduced. Subnet Y is a subnet to which a storage 104 as a service provision apparatus belongs, and storage 2 belongs to subnet 2 in the case where information processing system 100 has the same configuration as configuration example 2. Accordingly, internal condition object (EaDiv1-5(Net2)) is generated (internal condition object 1722c in FIG. 17). Also, rule loader program 122 generates OR operator object 1631b (not shown in FIG. 17) on the upstream side of the generated internal condition object in the IF part. Rule loader program 122 then generates a coupling from the generated OR operator object 1631b toward the generated internal condition object. Rule loader program 122 thereafter advances the process to step 3009.

(Step 3009) Rule loader program 122 generates condition objects corresponding to conditions relating to network apparatuses 103 in subnet Y (an IP switch in the divided rule in FIG. 12). If condition objects corresponding to the conditions exist in the rule memory data, the corresponding objects are not generated. Already existing conditions objects can be used as described above, so that the amount of rule memory data can be reduced. In the case where information processing system 100 has the same configuration as configuration example 2, subnet Y is subnet 2 and switch 4 belongs to subnet 2. Accordingly, a condition object corresponding to a condition relating to switch 4 is generated. Also, rule loader program 122 generates a coupling from each generated condition object toward the OR operator object 1631b generated in step 3008. Rule loader program 122 thereafter advances the process to step 3010.

<1.2.3. Subnet X Boundary Router Relationship>

(Step 3010) Rule loader program 122 searches for a router existing as a boundary router on subnet X (a router through which subnets are coupled together) and used for communication between subnet X and subnet Y. Rule loader program 122 then generates a condition object corresponding to a condition relating to the router searched for. If a condition object corresponding to the condition relating to the corresponding router exists in the rule memory data, the corresponding object is not generated. Already existing condition objects can be used as described above, so that the amount of rule memory data can be reduced. Further, rule loader program 122 makes a coupling from the generated condition object toward OR operator object 1631b generated in step 3003. Rule loader program 122 thereafter advances the process to step 3011.

<1.2.4. Subnet Y Boundary Router Relationship>

(Step 3011) Rule loader program 122 searches for a router existing as a boundary router on subnet Y and used for communication between subnet X and subnet Y. Rule loader program 122 then generates a condition object corresponding to a condition relating to the router searched for. If a condition object corresponding to the condition relating to the corresponding router exists in the rule memory data, the corresponding object is not generated. Already existing condition objects can be used as described above, so that the amount of rule memory data can be reduced. Further, rule loader program 122 makes a coupling from the generated condition object toward OR operator object 1631b generated in step 3003. Rule loader program 122 thereafter advances the process to step 3012.

<1.2.5. Internal Condition Object (EaDiv1-3(NetX-NetY))

(Step 3012) Rule loader program 122 searches for network apparatus 103 (an IP switch in the divided rule in FIG. 12) positioned between subnet X and subnet Y and used for communication between subnet X and subnet Y based on the details of internal condition 1223 extracted from divided rule 1213. In this step, any of routers (boundary routers) in subnets X and Y for coupling to other subnets is not searched for. These boundary routers may be searched for in step 3012 without being searched for in steps 3010 and 3011. Rule loader program 122 thereafter advances the process to step 3013.

(Step 3013) Rule loader program 122 generates, in the IF part, an internal condition object (EaDiv1-3(NetZ)) corresponding to internal condition 1223 extracted from divided rule 1213. If internal condition object (EaDiv1-3(NetZ)) corresponding to internal condition 1223 exists in the rule memory data, the corresponding object is not generated. Already existing internal condition objects can be used as described above, so that the amount of rule memory data can be reduced. For example, this internal condition object (EaDiv1-3(NetZ)) can be used in common in cause analysis on a service provision apparatus and a service use apparatus between the two subnets connected to each other through the medium of subnet Z. In the case where information processing system 100 has the same configuration as configuration example 2, subnet 0 exists between subnet 1 and subnet 2. Accordingly, internal condition object (EaDiv1-3(Net0)) is generated (internal condition object 722b in FIG. 17). Also, rule loader program 122 generates OR operator object 1631b on the upstream side of the generated internal condition object in the IF part. Rule loader program 122 then generates a coupling from the generated OR operator object 1631b toward the generated internal condition object. Rule loader program 122 thereafter advances the process to step 3014.

(Step 3014) Rule loader program 122 generates condition objects corresponding to conditions relating to network apparatuses 103 (an IP switch in the divided rule in FIG. 12) existing between subnet X and subnet Y. If condition objects corresponding to the conditions exist in the rule memory data, the corresponding objects are not generated. Already existing condition objects can be used as described above, so that the amount of rule memory data can be reduced. In the case where information processing system 100 has the same configuration as configuration example 2, subnet 0 intermediates between subnet 1 and subnet 2, and switch 2 and switch 3 belong to subnet 0. Accordingly, condition objects corresponding to conditions respectively relating to switch 2 and switch 3 are generated. Rule loader program 122 then generates couplings from the generated condition objects toward OR operator object 1631b generated in step 3008. Rule loader program 122 thereafter advances the process to step 3015.

<1.3. Generation of Internal Condition Object Corresponding to Service Provision Apparatus or Service Use Apparatus>

(Step 3015) Rule loader program 122 identifies, by referring to divided rule 1201, a service provision apparatus or a service use apparatus with which an event is specified in divided rule 1201 in service provision or service use apparatuses relating to divided rule 1201. In the case where information processing system 100 has the same configuration as configuration example 2, server 1, server 2 and storage 2 correspond to service provision or service provision apparatuses relating to divided rule 1201, but no event relating to storage 102 is specified in divided rule 1201. In the case where information processing system 100 has the same configuration as configuration example 2, therefore, server 1 and server 2 are identified.

(Step 3016) Rule loader program 122 generates condition objects corresponding to conditions respectively relating to the service provision or service use apparatuses identified in step 3015. If the condition objects corresponding to the conditions exist in the rule memory data, the corresponding objects are not generated. Already existing condition objects can be used as described above, so that the amount of rule memory data can be reduced. In the case where information processing system 100 has the same configuration as configuration example 2, condition objects corresponding to conditions respectively relating to server 1 and server 2 are generated. Also, rule loader program 122 generates AND operator object 1631a on the downstream side of the generated condition objects in the IF part. Rule loader program 122 then generates couplings from the generated AND operator object 1631a toward the generated condition objects. Rule loader program 122 thereafter advances the process to step 3015.

(Step 3017) Rule loader program 122 generates a coupling from the aggregate internal condition object (Ea(NetX-NetY)) generated in step 3003 toward AND operator object 1631b generated in step 3016. Rule loader program 122 thereafter advances the process to step 3015.

<2. Generation of THEN Part of Rule Memory Data>

<2.1. Generation of Aggregate Internal Object (Ea(NetX-NetY))>

(Step 3018) Rule loader program 122 generates OR operator objects in the THEN part and generates couplings from AND operator objects 1631b generated in step 3016 toward the generated OR operators. The thickness of each coupling is the number of inputs of the coupled AND operator object 1631b. Rule loader program 122 thereafter advances the process to step 3019.

(Step 3019) Rule loader program 122 generates an aggregate internal conclusion object (Ea(NetX-NetY)) in the THEN part. If an aggregate internal conclusion object (Ea(NetX-NetY)) exists in the rule memory data, the corresponding aggregate internal conclusion object is not generated. An already existing aggregate internal conclusion object can be used as described above, so that the amount of rule memory data can be reduced. In the case where information processing system 100 has the same configuration as configuration example 2, an aggregate internal conclusion object (Ea(Net1-Net2)) is generated (aggregate internal conclusion object 1741 in FIG. 17). Also, rule loader program 122 generates a coupling from OR operator object 1631b generated in step 3018 toward the generated aggregate internal conclusion object. The thickness of this coupling is the same as the thickness of the inputs of the coupled OR operator object 1631b. The rule loader program 122 thereafter advances the process to step 3020.

<2.2. Generation of Internal Conclusion Object>

<2.2.1. Generation of Internal Conclusion Object (EaDiv1-1(NetX))>

(Step 3020) Rule loader program 122 generates an internal conclusion object (EaDiv1-1(NetX)) in the THEN part. If an internal conclusion object (EaDiv1-1(NetX)) exists in the rule memory data, the corresponding object is not generated. An already existing internal conclusion object can be used as described above, so that the amount of rule memory data can be reduced. In the case where information processing system 100 has the same configuration as configuration example 2, an internal conclusion object (EaDiv1-1(Net1)) is generated (internal conclusion object 1742a in FIG. 17). Also, rule loader program 122 generates a coupling from the aggregate internal conclusion object (Ea(NetX-NetY)) generated in step 3019 toward the generated internal conclusion object. The thickness of this coupling is the same as the thickness of the input of the coupled aggregate internal conclusion object. This coupling may be made through OR operator object 1631b or AND operator object 1631a. Rule loader program 122 thereafter advances the process to 3021.

(Step 3021) Rule loader program 122 repeats processing in the following steps 3021-1 to 3021-4 with respect to each of network apparatuses 103 in subnet X searched for in step 3004. After the completion of processing with respect to the apparatuses, rule loader program 122 advances the process to step 3022. Rule loader program 122 first selects one of network apparatuses 103 in subnet X searched for in step 3004 (referred to as “target apparatus” in the following steps 3021-1 to 3021-4).

(Step 3021-1) Rule loader program 122 generates a conclusion object 1612 corresponding to a conclusion relating to the target apparatus and BLEND operator object 1631c. If a conclusion object corresponding to a conclusion relating to the target apparatus exists in the rule memory data, the corresponding object is not generated. An already existing conclusion object can be used as described above, so that the mount of rule memory data can be reduced. Rule loader program 122 thereafter advances the process to step 3021-2.

(Step 3021-2) Rule loader program 122 generates a coupling from BLEND operator object 1631c generated in step 3021-1 toward the corresponding conclusion object generated in step 3021-1. Rule loader program 122 thereafter advances the process to step 3021-3.

(Step 3021-3) Rule loader program 122 generates a coupling from the internal conclusion object (EaDiv1-1(NetX)) generated in step 3020 toward the basic input of BLEND operator object 1631c generated in step 3021-1. The thickness of this coupling is equal to the thickness of the input of the coupled internal conclusion object (EaDiv1-1(NetX)). Rule loader program 122 thereafter advances the process to step 3021-4.

(Step 3021-4) Rule loader program 122 generates a coupling from the condition object corresponding to the condition relating to the target apparatus toward the delta input of BLEND operator object 1631c generated in step 3021-1.

<2.2.2. Generation of Internal Conclusion Object (EaDiv1-5(NetY))>

(Step 3022) Rule loader program 122 generates an internal conclusion object (EaDiv1-5(NetY)) in the THEN part. If internal conclusion object (EaDiv1-5(NetX)) exists in the rule memory data, the corresponding object is not generated. An already existing internal conclusion object can be used as described above, so that the amount of rule memory data can be reduced. In the case where information processing system 100 has the same configuration as configuration example 2, an internal conclusion object (EaDiv1-5(Net2)) is generated (internal conclusion object 1742c in FIG. 17). Also, rule loader program 122 generates a coupling from the aggregate internal conclusion object (Ea(NetX-NetY)) generated in step 3019 toward the generated internal conclusion object. The thickness of this coupling is the same as the thickness of the input of the coupled aggregate internal conclusion object. This coupling may be made through OR operator object 1631b or AND operator object 1631a. Rule loader program 122 thereafter advances the process to step 3023.

(Step 3023) Rule loader program 122 repeats processing in the following steps 3023-1 to 3023-4 with respect to each of network apparatuses 103 in subnet Y searched for in step 3007. After the completion of processing with respect to the apparatuses, rule loader program 122 advances the process to step 3024. Rule loader program 122 first selects one of network apparatuses 103 in subnet Y searched for in step 3007 (referred to as “target apparatus” in the following steps 3023-1 to 3023-4).

(Step 3023-1) Rule loader program 122 generates a conclusion object corresponding to a conclusion relating to the target apparatus and BLEND operator object 1631c. Rule loader program 122 thereafter advances the process to step 3023-2.

(Step 3023-2) Rule loader program 122 generates a coupling from BLEND operator object 1631c generated in step 3023-1 toward the corresponding conclusion object generated in the same step 3023-1. Rule loader program 122 thereafter advances the process to step 3023-3.

(Step 3023-3) Rule loader program 122 generates a coupling from the internal conclusion object (EaDiv1-5(NetY)) generated in step 3022 toward the basic input of BLEND operator object 1631c generated in step 3023-1. The thickness of this coupling is equal to the thickness of the input of the coupled internal conclusion object (EaDiv1-5(NetY)). Rule loader program 122 thereafter advances the process to step 3023-4.

(Step 3023-4) Rule loader program 122 generates a coupling from the condition object corresponding to the condition relating to the target apparatus toward the delta input of BLEND operator object 1631c generated in step 3023-1.

<2.2.3. Subnet X Boundary Router Relationship>

(Step 3024) Rule loader program 122 repeats processing in the following steps 3024-1 to 3024-4 with respect to each of boundary routers searched for in step 3010. After the completion of processing with respect to the routers, rule loader program 122 advances the process to step 3025. Rule loader program 122 first selects one of the boundary routers searched for in step 3010 (referred to as “target apparatus” in the following steps 3024-1 to 3024-4).

(Step 3024-1) Rule loader program 122 generates a conclusion object corresponding to a conclusion relating to the target apparatus and BLEND operator object 1631c. Rule loader program 122 thereafter advances the process to step 3024-1.

(Step 3024-2) Rule loader program 122 generates a coupling from BLEND operator object 1631c generated in step 3024-1 toward the corresponding conclusion object generated in step 3024-1. Rule loader program 122 thereafter advances the process to step 3024-3.

(Step 3024-3) Rule loader program 122 generates a coupling from the aggregate internal conclusion object (Ea(NetX-NetY)) generated in step 3019 toward the basic input of BLEND operator object 1631c generated in step 3024-1. The thickness of this coupling is equal to the thickness of the input of the coupled aggregate internal conclusion object (Ea(NetX-NetY)). Rule loader program 122 thereafter advances the process to step 3024-4.

(Step 3024-4) Rule loader program 122 generates a coupling from the condition object corresponding to the condition relating to the target apparatus toward the delta input of BLEND operator object 1631c generated in step 3024-1.

<2.2.4. Subnet Y Boundary Router Relationship>

(Step 3025) Rule loader program 122 repeats processing in the following steps 3025-1 to 3025-4 with respect to each of boundary routers searched for in step 3011. After the completion of processing with respect to the routers, rule loader program 122 advances the process to step 3026. Rule loader program 122 first selects one of the boundary routers searched for in step 3011 (referred to as “target apparatus” in the following steps 3025-1 to 3025-4).

(Step 3025-1) Rule loader program 122 generates a conclusion object corresponding to a conclusion relating to the target apparatus and BLEND operator object 1631c. Rule loader program 122 thereafter advances the process to step 3025-2.

(Step 3025-2) Rule loader program 122 generates a coupling from BLEND operator object 1631c generated in step 3025-1 toward the corresponding conclusion object generated in step 3025-1. Rule loader program 122 thereafter advances the process to step 3025-3.

(Step 3025-3) Rule loader program 122 generates a coupling from the aggregate internal conclusion object (Ea(NetX-NetY)) generated in step 3019 toward the basic input of BLEND operator object 1631c generated in step 3025-1. The thickness of this coupling is equal to the thickness of the input of the coupled aggregate internal conclusion object (Ea(NetX-NetY)). Rule loader program 122 thereafter advances the process to step 3025-4.

(Step 3025-4) Rule loader program 122 generates a coupling from the condition object corresponding to the condition relating to the target apparatus toward the delta input of BLEND operator object 1631c generated in step 3025-1.

<2.2.5. Generation of Internal Conclusion Object (EaDiv1-3(NetZ))>

(Step 3026) Rule loader program 122 generates an internal conclusion object (EaDiv1-3(NetZ)) in the THEN part. If internal conclusion object (EaDiv1-3(NetZ)) exists in the rule memory data, the corresponding object is not generated. An already existing internal conclusion object can be used as described above, so that the amount of rule memory can be reduced. In the case where information processing system 100 has the same configuration as configuration example 2, an internal conclusion object (EaDiv1-3(Net0)) is generated (internal conclusion object 1742b in FIG. 17). Also, rule loader program 122 generates a coupling from the aggregate internal conclusion object (Ea(NetX-NetY)) generated in step 3019 toward the generated internal conclusion object. The thickness of this coupling is equal to the thickness of the input of the coupled aggregate internal conclusion object. This coupling may be made through OR operator object 1631b or AND operator object 1631a. Rule loader program 122 thereafter advances the process to step 3027.

(Step 3027) Rule loader program 122 repeats processing in the following steps 3027-1 to 3027-4 with respect to each of network apparatuses 103 existing between subnet X and subnet Y and searched for in step 3012. After the completion of processing with respect to the apparatuses, rule loader program 122 advances the process to step 3028. Rule loader program 122 first selects one of network apparatuses 103 existing between subnet X and subnet Y and searched for in step 3012 (referred to as “target apparatus” in the following steps 3027-1 to 3027-4).

(Step 3027-1) Rule loader program 122 generates a conclusion object corresponding to a conclusion relating to the target apparatus and BLEND operator object 1631c. Rule loader program 122 thereafter advances the process to step 3027-2.

(Step 3027-2) Rule loader program 122 generates a coupling from BLEND operator object 1631b generated in step 3027-1 toward the corresponding conclusion object generated in step 3027-1. Rule loader program 122 thereafter advances the process to step 3027-3.

(Step 3027-3) Rule loader program 122 generates a coupling from the internal conclusion object (EaDiv1-3(NetZ)) generated in step 3026 toward the basic input of BLEND operator object 1631c generated in step 3027-1. The thickness of this coupling is equal to the thickness of the input of the coupled internal conclusion object (EaDiv1-3(NetZ)). Rule loader program 122 thereafter advances the process to step 3027-4.

(Step 3027-4) Rule loader program 122 generates a coupling from the condition object corresponding to the condition relating to the target apparatus toward the delta input of BLEND operator object 1631c generated in step 3027-1.

(Step 3028) Rule loader program 122 ends loop 1.

Matching ratio calculation processing will be described.

Matching ratio calculation processing is performed by matching ratio evaluation program 125. As already described with reference to FIGS. 16 and 17, each object included in the rule memory data outputs a value according to the output from the source object. When the condition object outputs true (1), the output from the condition object flows downstream by following the connection relationships between the objects. The output finally reaches the conclusion object to cause the conclusion object to output the matching ratio. For example, when one of the condition objects newly outputs true (1), matching ratio evaluation program 125 performs recursive processing described below.

(Step 4001) Matching ratio evaluation program 125 identifies a target object (an object coupled on the downstream side, hereinafter referred to as “object A”) for the condition object that has changed its output value. Matching ratio evaluation program 125 thereafter advances the process to step 4002.

(Step 4002) Matching ratio evaluation program 125 performs processing on each object A according to the kind of the object to produce a new output value. Matching ratio evaluation program 125 thereafter advances the process to step 4003.

(Step 4003) Matching ratio evaluation program 125 identifies a target object for object A that has produced a new output value (hereinafter referred to as “object B”). If object B is a conclusion object, matching ratio evaluation program 125 saves the new output value as a matching ratio. If object B is an object other than the conclusion object, matching ratio evaluation program 125 sets object B as “one of objects A” and performs processing in step 4002.

By the above-described processing, calculation of the matching ratio is started from the condition object relating to an event made true (1) by event detection. Even in a case where with a lapse of a certain time period the output of one of the condition event is changed from true (1) to 0 signifying a state where no event is detected, the matching ratio can be recalculated by performing the same processing as that described above. Execution of each object may be controlled by a method different from that described above.

After calculation of the matching ratio performed as described above, matching ratio evaluation program 125 detects from the rule memory data conclusion object 1612 at which the matching ratio exceeds a predetermined value, determines as a root cause the event corresponding to the conclusion managed by this conclusion object 1612, and outputs the information on the root cause, for example, to the display 117 through the input/output device 114. The information on the root cause event may be output (transmitted) to a different apparatus to be displayed on this apparatus.

The general rule means that when an event contained in a conclusion occurs, it is necessary that the event contained in the condition occur. However, it is not always possible to detect an event from a node apparatus under such an influence. In the case of determining an influenced node apparatus with a monitoring computer using rule memory data according to the present embodiment, however, it is difficult to trace the scope of influence through Aggregate event (Ea(NetX-NetY)). Therefore CPU 111 may identify a corresponding condition event (indicating an influenced node apparatus) by searching the corresponding rule with a designated node apparatus and a kind of event used as a key, temporarily produce the condition event in storage resource 112 and display the condition event on display apparatus 117, for example.

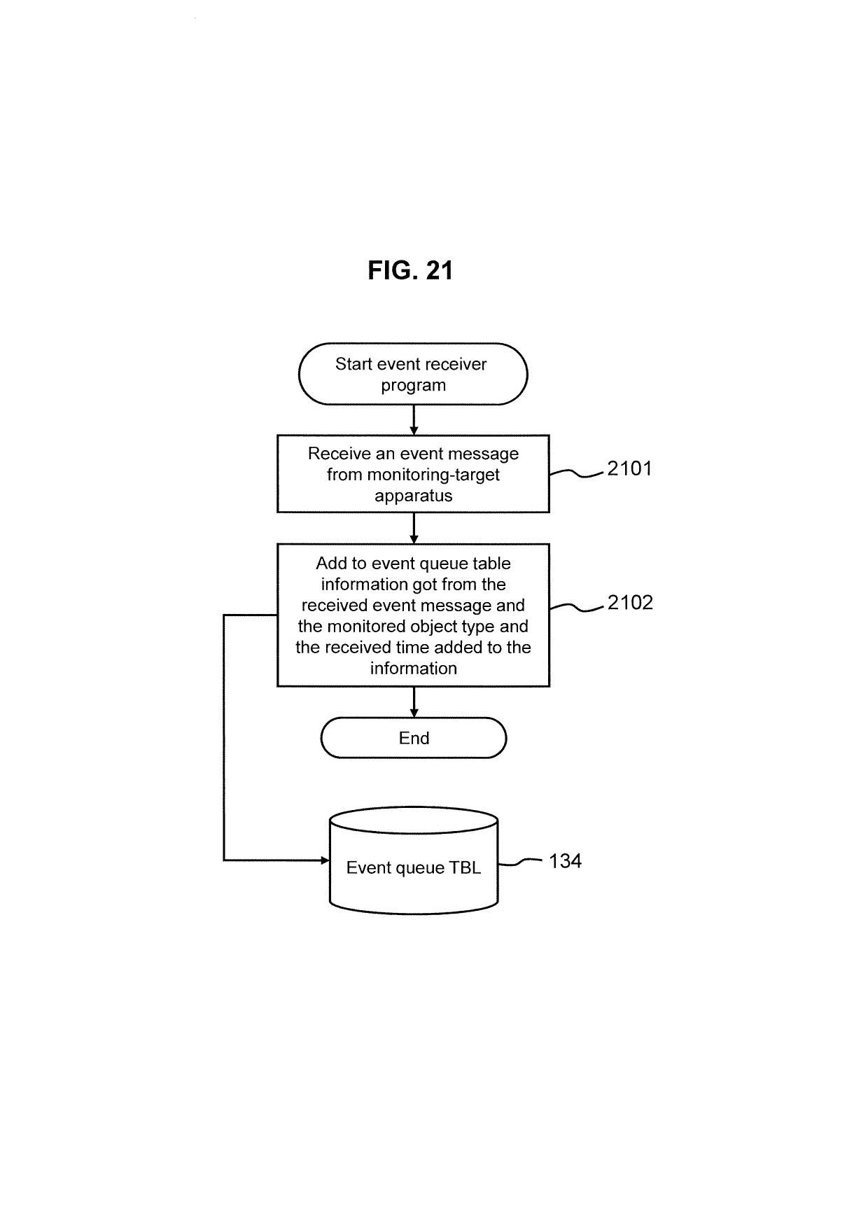

FIG. 21 is a flowchart of event receiving processing.

(Step 2101) Event receiver program 123 receives event message 1401 from a monitoring-target apparatus (more specifically, monitoring agent 141 or 166 in the monitoring-target apparatus).

(Step 2102) Event receiver program 123 obtains monitoring-target name 1411 and event type 1412 from event message 1401 received in step 2101 and prepares event information 1511 by adding the monitoring-target type and the received date and time to the obtained information items 1411 and 1412. Event receiver program 123 adds prepared event information 1511 to event queue table 134 and ends the process.

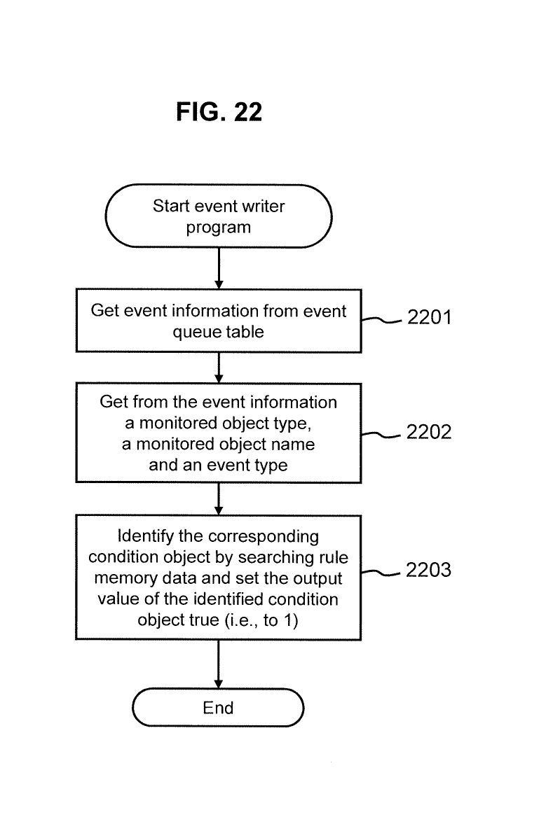

FIG. 22 is a flowchart of event writing processing.

(Step 2201) Event writer program 124 obtains one group of event information 1511 from event queue table 134.

(Step 2202) Event writer program 124 obtains monitoring-target type 1501, monitoring-target name 1502 and event type 1503 from event information 1511 obtained in step 2201.

(Step 2203) Event writer program 124 thereafter searches the rule memory data by using obtained monitoring-target name 1502 and event type 1503 as a key to identify a condition object matching in monitoring-target name 1502 and event type 1503. Event writer program 124 sets the output value of the identified condition object true (i.e., to 1) and ends the process. When the output value of the object is changed in this way, the above-described matching ratio calculation processing is executed.

The embodiment has been described but the present invention is not limited to this embodiment. Needless to say, various changes and modifications can be made in the embodiment without departing from the gist of the invention. For example, monitoring computer 101 may be configured by a network apparatus, e.g., a switch.

### REFERENCE SIGNS LIST

101: Monitoring computer
102: Server
103: Network apparatus
104: Storage

1. An information system comprising:
a plurality of network apparatuses forming a plurality of subnetworks;
a plurality of node apparatuses belonging to the plurality of subnetworks; and
a computer configured to identify a cause of an event which has occurred, the computer having:
a storage resource; and
a control device coupled to the storage resource,
wherein the storage resource is configured to store one or more rules and subnetwork information indicating to which networks the network apparatuses and the node apparatuses belong,
wherein each rule includes topology information about a topology including a node apparatus at one end, a node apparatus at the other end and a network apparatus relaying between the node apparatuses, conditions indicating events in the topology, and a conclusion indicating an event occurring as a cause satisfying the conditions, and
wherein
(A) the control device is configured to generate rule memory data and store the rule memory data in the storage resource by performing (a1) to (a13):
(a1) identifying one or more of the network apparatuses in a first one of the subnetworks based on the subnetwork information, generating one or more first condition objects each configured to manage information on the occurrence of the event corresponding to the condition in the rule, in the network apparatus, when the one or more first condition objects do not exist in the rule memory data, and including the generated one or more first condition objects in the rule memory data;
(a2) generating a first internal condition object configured to aggregate information on the occurrences of all the events of the one or more first condition objects, when the first internal condition object does not exist in the rule memory data, and including the generated first internal condition object in the rule memory data;
(a3) associating the first internal condition object with the first condition objects;
(a4) identifying one or more of the network apparatuses in a second one of the subnetworks based on the subnetwork information, generating one or more second condition objects each configured to manage information on the occurrence of the event corresponding to the condition in the rule, in the network apparatus, when the one or more second condition objects do not exist in the rule memory data, and including the generated one or more second condition objects in the rule memory data;
(a5) generating a second internal condition object configured to aggregate information on the occurrences of all the events of the one or more second condition objects, when the second internal condition object does not exist in the rule memory data, and including the generated second internal condition object in the rule memory data;
(a6) associating the second internal condition object with the second condition objects;
(a7) generating an aggregate internal condition object configured to manage aggregate information as an aggregation of information on the occurrences of the events of the first internal condition object and the second internal condition object, when the aggregate internal condition object does not exist in the rule memory data, and including the generated aggregate internal condition object in the rule memory data;
(a8) associating the aggregate internal condition object with the first and second internal condition objects;
(a9) identifying a plurality of the node apparatuses in the first subnetwork based on the subnetwork information, generating a plurality of third condition objects each configured to manage information on the occurrence of the event corresponding to the condition in the rule, in the node apparatus, when the plurality of third condition objects do not exist in the rule memory data, and including the generated plurality of third condition objects in the rule memory data;
(a10) generating an aggregate internal conclusion object configured to manage determination information for determining a condition based on the aggregate information from the aggregate internal condition object and the information on the occurrences of the events of the third condition objects, when the aggregate internal conclusion object does not exist in the rule memory data, and including the generated aggregate internal conclusion object in the rule memory data;
(a11) associating the aggregate internal conclusion object with the aggregate internal condition object and the third condition objects;
(a12) generating a plurality of conclusion objects each configured to manage a measure indicating a possibility that a conclusion indicating the event occurring in one of the network apparatuses in the first subnetwork and the network apparatuses in the second subnetwork shows a cause, when the plurality of conclusion objects do not exist in the rule memory data, and including the generated plurality of conclusion objects in the rule memory data; and
(a13) associating the plurality of conclusion objects with the aggregate internal conclusion object, and
(B) the control device is configured to receive information on the occurrences of the events in the plurality of network apparatuses or the plurality of node apparatuses, to identify the condition object managing the received occurrence information based on the rule memory data, to update the information on the occurrence of the event managed by the identified condition object, to update the measure of the conclusion object by tracing the association with the condition object and updating the information managed by each object influenced by the update of the occurrence information, and to identify the cause of the event based on the updated measure of the conclusion object and output the cause of the event.

2. An information system according to claim 1, wherein a third subnetwork exists between the first subnetwork and the second subnetwork,
wherein the control device is configured to further execute (a14) to (a16) in (A):
(a14) generating, based on the subnetwork information, one or more fourth condition objects configured to manage information on the occurrences of the events corresponding to the conditions in the rules, in the one or more network apparatuses in the third subnetwork, when the one or more fourth condition objects do not exist in the rule memory data, and including the generated one or more fourth condition objects in the rule memory data;
(a15) generating a third internal condition object configured to aggregate information on the occurrences of all the events of the one or more fourth condition objects, when the third internal condition object does not exist in the rule memory data, and including the generated third internal condition object in the rule memory data; and
(a16) associating the third internal condition object with the fourth condition objects,
wherein the aggregate internal condition object generated in (a7) is an object configured to manage aggregate information as an aggregation of information on the occurrences of the events of the first internal condition object, the second internal condition object and the third internal condition object, and
wherein the control device is configured to associate the aggregate internal condition object with the first, second and third internal condition objects in (a8).

3. An information system according to claim 2, wherein the measure in the conclusion object is determined on the basis of information on the occurrence of the event of the condition object managing the information on the occurrence of the event corresponding to the conclusion object and the determination information from the aggregate internal conclusion object.

4. A computer configured to identify a cause of an event which has occurred in an information system having a plurality of network apparatuses forming a plurality of subnetworks, and a plurality of node apparatuses belonging to the plurality of subnetworks, the computer comprising:
a storage resource; and
a control device coupled to the storage resource,
wherein the storage resource is configured to store one or more rules and subnetwork information indicating to which networks the network apparatuses and the node apparatuses belong,
wherein each rule includes topology information about a topology including a node apparatus at one end, a node apparatus at the other end and a network apparatus relaying between the node apparatuses, conditions indicating events in the topology, and a conclusion indicating an event occurring as a cause satisfying the conditions, and
wherein
(A) the control device is configured to generate rule memory data and store the rule memory data in the storage resource by performing (a1) to (a13):
(a1) identifying one or more of the network apparatuses in a first one of the subnetworks based on the subnetwork information, generating one or more first condition objects each configured to manage information on the occurrence of the event corresponding to the condition in the rule, in the network apparatus, when the one or more first condition objects do not exist in the rule memory data, and including the generated one or more first condition objects in the rule memory data;
(a2) generating a first internal condition object configured to aggregate information on the occurrence of all the events of the one or more first condition objects, when the first internal condition object does not exist in the rule memory data, and including the generated first internal condition object in the rule memory data;
(a3) associating the first internal condition object with the first condition objects;
(a4) identifying one or more of the network apparatuses in a second one of the subnetworks based on the subnetwork information, generating one or more second condition objects each configured to manage information on the occurrence of the event corresponding to the condition in the rule, in the network apparatus, when the one or more second condition object do not exist in the rule memory data, and including the generated one or more second condition objects in the rule memory data;
(a5) generating a second internal condition object configured to aggregate information on the occurrences of all the events of the one or more second condition objects, when the second internal condition object does not exist in the rule memory data, and including the generated second internal condition object in the rule memory data;
(a6) associating the second internal condition object with the second condition objects;
(a7) generating an aggregate internal condition object configured to manage aggregate information as an aggregation of information on the occurrences of the events of the first internal condition object and the second internal condition object, when the aggregate internal condition object does not exist in the rule memory data, and including the generated aggregate internal condition object in the rule memory data;
(a8) associating the aggregate internal condition object with the first and second internal condition objects;
(a9) identifying a plurality of the node apparatuses in the first subnetwork based on the subnetwork information, generating a plurality of third condition objects each configured to manage information on the occurrence of the event corresponding to the condition in the rule, in the node apparatus, when the plurality of third condition objects do not exist in the rule memory data, and including the generated plurality of third condition objects in the rule memory data;
(a10) generating an aggregate internal conclusion object configured to manage determination information for determining a condition based on the aggregate information from the aggregate internal condition object and the information on the occurrences of the events of the third condition objects, when the aggregate internal conclusion object does not exist in the rule memory data, and including the generated aggregate internal conclusion object in the rule memory data;
(a11) associating the aggregate internal conclusion object with the aggregate internal condition object and the third condition objects;
(a12) generating a plurality of conclusion objects each configured to manage a measure indicating a possibility that a conclusion indicating the event occurring in one of the network apparatuses in the first subnetwork and the network apparatuses in the second subnetwork shows a cause, when the plurality of conclusion objects do not exist in the rule memory data, and including the generated plurality of conclusion objects in the rule memory data; and
(a13) associating the plurality of conclusion objects with the aggregate internal conclusion object, and
(B) the control device is configured to receive information on the occurrences of the events in the plurality of network apparatuses or the plurality of node apparatuses, to identify the condition object managing the received occurrence information based on the rule memory data, to update the information on the occurrence of the event managed by the identified condition object, to update the measure of the conclusion object by tracing the association with the condition object and updating the information managed by each object influenced by the update of the occurrence information, and to identify the cause of the event based on the updated measure of the conclusion object and output the cause of the event.

5. A computer according to claim 4, wherein a third subnetwork exists between the first subnetwork and the second subnetwork,
wherein the control device is configured to further execute (a14) to (a16) in (A):
(a14) generating, based on the subnetwork information, one or more fourth condition objects configured to manage information on the occurrences of the events corresponding to the conditions in the rules, in the one or more network apparatuses in the third subnetwork, when the one or more fourth condition objects do not exist in the rule memory data, and including the generated one or more fourth condition objects in the rule memory data;
(a15) generating a third internal condition object configured to aggregate information on the occurrences of all the events of the one or more fourth condition objects, when the third internal condition object does not exist in the rule memory data, and including the generated third internal condition object in the rule memory data; and
(a16) associating the third internal condition object with the fourth condition objects,
wherein the aggregate internal condition object generated in (a7) is an object configured to manage aggregate information as an aggregation of information on the occurrences of the events of the first internal condition object, the second internal condition object and the third internal condition object, and
wherein the control device is configured to associate the aggregate internal condition object with the first, second and third internal condition objects in (a8).

6. A computer according to claim 4, wherein the measure in the conclusion object is determined on the basis of information on the occurrence of the event of the condition object managing the information on the occurrence of the event corresponding to the conclusion object and the determination information from the aggregate internal conclusion object.

7. A method of identifying a cause of an event which has occurred in an information system having a plurality of network apparatuses forming a plurality of subnetworks, and a plurality of node apparatuses belonging to the plurality of subnetworks, the method comprising:
(A) making a computer generate rule memory data and store the rule memory data in a storage resource by performing (a1) to (a13), the storage resource storing one or more rules and subnetwork information, each rule including topology information about a topology including a node apparatus at one end, a node apparatus at the other end and a network apparatus relaying between the node apparatuses, conditions indicating events in the topology, and a conclusion indicating an event occurring as a cause satisfying the conditions, the subnetwork information indicating to which networks the network apparatuses and the node apparatuses belong, the computer performing:
(a1) identifying one or more of the network apparatuses in a first one of the subnetworks based on the subnetwork information, generating one or more first condition objects each configured to manage information on the occurrence of the event corresponding to the condition in the rule, in the network apparatus, when the one or more first condition objects do not exist in the rule memory data, and including the generated one or more first condition objects in the rule memory data;
(a2) generating a first internal condition object configured to aggregate information on the occurrence of all the events of the one or more first condition objects, when the first internal condition object does not exist in the rule memory data, and including the generated first internal condition object in the rule memory data;
(a3) associating the first internal condition object with the first condition objects;
(a4) identifying one or more of the network apparatuses in a second one of the subnetworks based on the subnetwork information, generating one or more second condition objects each configured to manage information on the occurrence of the event corresponding to the condition in the rule, in the network apparatus, when the one or more second condition objects do not exist in the rule memory data, and including the generated one or more second condition objects in the rule memory data;
(a5) generating a second internal condition object configured to aggregate information on the occurrences of all the events of the one or more second condition objects, when the second internal condition object does not exist in the rule memory data, and including the generated second internal condition object in the rule memory data;
(a6) associating the second internal condition object with the second condition objects;
(a7) generating an aggregate internal condition object configured to manage aggregate information as an aggregation of information on the occurrences of the events of the first internal condition object and the second internal condition object, when the aggregate internal condition object does not exist in the rule memory data, and including the generated aggregate internal condition object in the rule memory data;
(a8) associating the aggregate internal condition object with the first and second internal condition objects;
(a9) identifying a plurality of the node apparatuses in the first subnetwork based on the subnetwork information, generating a plurality of third condition objects each configured to manage information on the occurrence of the event corresponding to the condition in the rule, in the node apparatus, when the plurality of third condition objects do not exist in the rule memory data, and including the generated plurality of third condition objects in the rule memory data;
(a10) generating an aggregate internal conclusion object configured to manage determination information for determining a condition based on the aggregate information from the aggregate internal condition object and the information on the occurrences of the events of the third condition objects, when the aggregate internal conclusion object does not exist in the rule memory data, and including the generated aggregate internal conclusion object in the rule memory data;
(a11) associating the aggregate internal conclusion object with the aggregate internal condition object and the third condition objects;
(a12) generating a plurality of conclusion objects each configured to manage a measure indicating a possibility that a conclusion indicating the event occurring in one of the network apparatuses in the first subnetwork and the network apparatuses in the second subnetwork shows a cause, when the plurality of conclusion objects do not exist in the rule memory data, and including the generated plurality of conclusion objects in the rule memory data; and
(a13) associating the plurality of conclusion objects with the aggregate internal conclusion object, and
(B) making the computer receive information on the occurrences of the events in the plurality of network apparatuses or the plurality of node apparatuses, identify the condition object managing the received occurrence information based on the rule memory data, update the information on the occurrence of the event managed by the identified condition object, update the measure of the conclusion object by tracing the association with the condition object and updating the information managed by each object influenced by the update of the occurrence information, and identify the cause of the event based on the updated measure of the conclusion object and output the cause of the event.

8. A method according to claim 7, wherein a third subnetwork exists between the first subnetwork and the second subnetwork,
wherein the computer further executes (a14) to (a16) in (A):
(a14) generating, based on the subnetwork information, one or more fourth condition objects configured to manage information on the occurrences of the events corresponding to the conditions in the rules, in the one or more network apparatuses in the third subnetwork, when the one or more fourth condition objects do not exist in the rule memory data, and including the generated one or more fourth condition objects in the rule memory data;
(a15) generating a third internal condition object configured to aggregate information on the occurrences of all the events of the one or more fourth condition objects, when the third internal condition object does not exist in the rule memory data, and including the generated third internal condition object in the rule memory data; and
(a16) associating the third internal condition object with the fourth condition objects,
wherein the aggregate internal condition object generated in (a7) is an object configured to manage aggregate information as an aggregation of information on the occurrences of the events of the first internal condition object, the second internal condition object and the third internal condition object, and
wherein the computer associates the aggregate internal condition object with the first, second and third internal condition objects in (a8).

9. A method according to claim 7, wherein the measure in the conclusion object is determined on the basis of information on the occurrence of the event of the condition object managing the information on the occurrence of the event corresponding to the conclusion object and the determination information from the aggregate internal conclusion object.
